(19) United States
(12) Patent Application Publication
(10) Pub. No.: US 2025/0210983 A1
(43) Pub. Date: Jun. 26, 2025

(54) CONTROL APPARATUS, POWER ADJUSTMENT APPARATUS, POWER APPARATUS, CONTROL SYSTEM, AND MANAGEMENT APPARATUS

(71) Applicant: NExT-e Solutions Inc., Tokyo (JP)

(72) Inventors: Fumiaki NAKAO, Shizuoka (JP); Takashi YAGI, Chiba (JP)

(21) Appl. No.: 19/075,793

(22) Filed: Mar. 11, 2025

Related U.S. Application Data
(63) Continuation of application No. PCT/JP2023/033266, filed on Sep. 12, 2023.

(30) Foreign Application Priority Data
Sep. 15, 2022 (JP) 2022-147218

(51) Int. Cl. H02J 1/08; H01M 10/42; H01M 10/48; H01M 50/512

(52) U.S. Cl. CPC H02J 1/084; H01M 10/425; H01M 10/482; H01M 50/512; H01M 2010/4271; H01M 2010/4278

(57) ABSTRACT

A control apparatus decides an upper limit of a magnitude of output power of a power apparatus configured such that electric storage apparatuses, which are attachable and detachable, are able to be connected in parallel, based on a maximum power supply value that is a maximum value of power which each of one or more first electric storage apparatuses, which are the electric storage apparatuses electrically connected to a power terminal of the power apparatus, is able to supply to the power apparatus, and/or decides an upper limit of a magnitude of input power of the power apparatus, based on a maximum power reception value that is a maximum value of power with which each of the one or more first electric storage apparatuses is able to be supplied from the power apparatus.

The contents of the following patent application(s) are incorporated herein by reference:
NO. 2022-147218 filed in JP on Sep. 15, 2022, and
NO. PCT/JP2023/033266 filed in WO on Sep. 12, 2023.

### BACKGROUND

### 1. TECHNICAL FIELD

The present invention relates to a control apparatus, a power adjustment apparatus, a power apparatus, a control system, and a management apparatus.

### 2. RELATED ART

In an electric storage system including a plurality of electric storage modules, the electric storage modules may be connected in parallel (for example, see Patent Document 1). Patent Documents 2 to 4 disclose an electric storage system that enables hot-swapping of electric storage modules.

### CITATION LIST

### Patent Documents

Patent Document 1: Japanese Patent Application Publication No. H11-98708

Patent Document 2: International Publication No. 2017/086349

Patent Document 3: International Publication No. 2017/086349

Patent Document 4: Japanese Patent Application Publication No. 2019-092257

### BRIEF DESCRIPTION OF THE DRAWINGS

FIG. 1 schematically illustrates an example of a system configuration of a power supply system 100.

FIG. 2 schematically illustrates an example of a system configuration of an electric storage module 20.

FIG. 3 schematically illustrates another example of the system configuration of the electric storage module 20.

FIG. 4 schematically illustrates an example of a system configuration of a module control unit 240.

FIG. 5 schematically illustrates an example of a circuit configuration of the electric storage module 20.

FIG. 6 schematically illustrates an example of a system configuration of an input/output control unit 180.

FIG. 7 schematically illustrates a specific example of a control method of the power supply system 100.

FIG. 8 schematically illustrates an example of a system configuration of a computer 3000.

### DESCRIPTION OF EXEMPLARY EMBODIMENTS

Hereinafter, (some) embodiment(s) of the present invention will be described, but the embodiment(s) do(es) not limit the invention according to the claims. Not all combinations of features described in the embodiments are essential for the solution of the invention. Also, the embodiment(s) will be described with reference to the drawings. The identical or similar parts in the drawings may be given the same reference numerals to omit the description that could otherwise overlap.

### Overview of Power Supply System 100

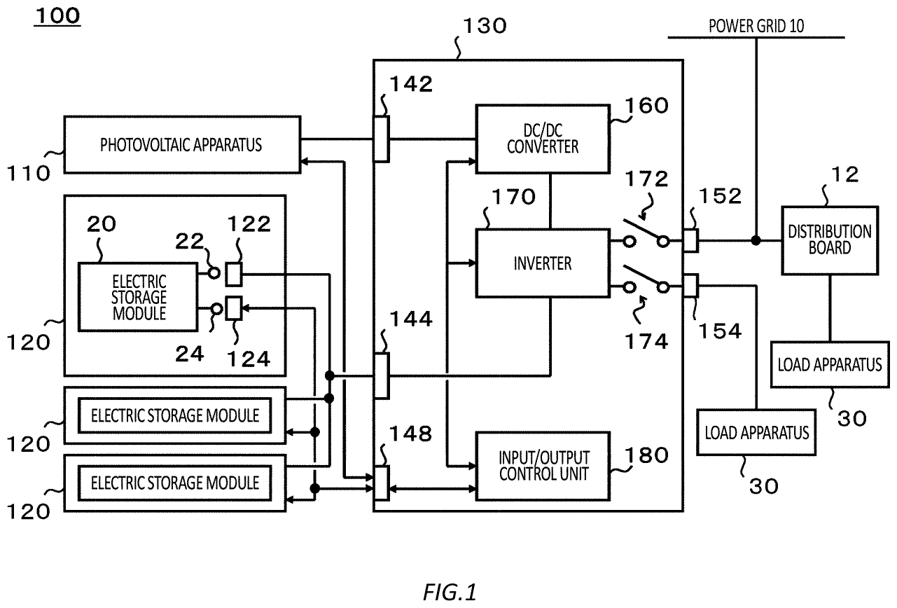

FIG. 1 schematically illustrates an example of a system configuration of a power supply system 100. In the present embodiment, the power supply system 100 includes, for example, a photovoltaic apparatus 110, one or a plurality of (may be referred to as one or more) slots 120, and a power conditioner 130.

In the present embodiment, for example, each of the one or more slots 120 is configured such that one or more electric storage modules 20 are attachable and detachable (may be referred to as “freely attached and detached”) thereto and therefrom. In the present embodiment, the electric storage module 20 includes, for example, a power connector 22 and a communication connector 24. In the present embodiment, the power conditioner 130 includes, for example, a power connector 142, a power connector 144, a communication connector 148, a power connector 152, a power connector 154, a DC/DC converter 160, an inverter 170, a switch 172, and a switch 174.

In the present embodiment, a case where the power supply system 100 is supplied with power from a power grid 10 is used as an example to describe details of the power supply system 100. In the present embodiment, a case where the power supply system 100 uses the power supplied from the power grid 10 (may be referred to as power from the power grid 10) to charge the electric storage module 20 held in at least one of a plurality of slots 120 is used as an example to describe details of the power supply system 100. In the present embodiment, a case where the power supply system 100 uses power generated by the photovoltaic apparatus 110 to charge the electric storage module 20 held in at least one of the plurality of slots 120 is used as an example to describe details of the power supply system 100.

In the present embodiment, a case where the power supply system 100 supplies at least one of (i) the power from the power grid 10, (ii) power accumulated in the electric storage module 20 held in at least one of the plurality of slots 120, or (iii) the power generated by the photovoltaic apparatus 110, via a distribution board 12 to a load apparatus 30 electrically connected to the distribution board 12 is used as an example to describe details of the power supply system 100. In the present embodiment, a case where the power supply system 100 supplies at least one of (i) the power from the power grid 10, (ii) the power accumulated in the electric storage module 20 held in at least one of the plurality of slots 120, or (iii) the power generated by the photovoltaic apparatus 110, to the load apparatus 30 electrically connected to the power connector 154 of the power conditioner 130 is used as an example to describe details of the power supply system 100.

### Overview of Each Unit Related to Power Supply System 100

In the present embodiment, the distribution board 12 branches the power supplied from the power grid 10 and the power conditioner 130. Accordingly, the distribution board 12 can supply power to the load apparatus 30 electrically connected to the distribution board 12.

In the present embodiment, the electric storage module 20 is configured to be attachable and detachable to and from the slot 120. For example, the electric storage module 20 is configured such that a user of the electric storage module 20 can freely attach and detach the electric storage module 20 to and from the slot 120. The electric storage module 20 may be configured such that the user of the electric storage module 20 can freely attach and detach the electric storage module 20 to and from the slot 120 without using a special tool. For example, the electric storage module 20 is configured to be accommodated in the slot 120. Accordingly, the electric storage module 20 can be held in the slot 120.

In the present embodiment, the electric storage module 20 is configured such that an electrical connection state between an electric storage unit arranged in the electric storage module 20 and a power connector 122 can be switched in a state where the power connector 22 and the power connector 122 are electrically connected. Details of the electric storage module 20 will be described later.

In the present embodiment, the power connector 22 is configured to be able to input and output power. The power connector 22 may include a set of power terminals. For example, when the electric storage module 20 is accommodated in the slot 120, the power connector 22 is electrically connected to the power connector 122 arranged in the slot 120. A connection method of the power connector 22 and the power connector 122 may be a wired connection method or a wireless connection method.

In the present embodiment, the communication connector 24 is configured to be able to transmit and receive signals. For example, when the electric storage module 20 is accommodated in the slot 120, the communication connector 24 is communicably connected to the communication connector 124 arranged in the slot 120. A connection method of the communication connector 24 and the communication connector 124 may be a wired connection method or a wireless connection method.

In the present embodiment, the load apparatus 30 operates using power. Details of the load apparatus 30 are not particularly limited.

In the present embodiment, the power supply system 100 supplies power to one or more load apparatuses 30. The power supply system 100 may supply power to the power grid 10. The power supply system 100 may generate or store power.

In the present embodiment, the photovoltaic apparatus 110 generates power using sunlight. An output terminal (not illustrated) of the photovoltaic apparatus 110 is electrically connected to the power connector 142 of the power conditioner 130. Accordingly, the photovoltaic apparatus 110 can supply the power generated by the photovoltaic apparatus 110 to the power conditioner 130. A communication terminal (not illustrated) of the power supply system 100 is communicably connected to the communication connector 148 of the power conditioner 130. Accordingly, the photovoltaic apparatus 110 can transmit and receive information to and from the power conditioner 130.

In the present embodiment, the slot 120 holds the electric storage module 20. A single slot 120 may hold a single electric storage module 20, and a single slot 120 may hold a plurality of electric storage modules 20. As described above, the slot 120 is configured such that the electric storage module 20 is attachable and detachable thereto and therefrom. In addition, the slot 120 is configured to be able to accommodate the electric storage module 20.

In the present embodiment, the slot 120 is electrically connected to the electric storage module 20 accommodated in the slot 120. In the present embodiment, the slot 120 is communicably connected to the electric storage module 20 accommodated in the slot 120.

In an embodiment, the slot 120 receives power output by the power conditioner 130, and supplies the power to one or more electric storage modules 20 (may be referred to as connection module(s)) which are electrically connected to the slot 120. Accordingly, the connection modules are charged. In another embodiment, the slot 120 receives power output by one or more connection modules, and supplies the power to the power conditioner 130. Accordingly, the connection modules are discharged.

In the present embodiment, the power connector 122 is configured to be able to input and output power. The power connector 122 may include a set of power terminals. For example, when the electric storage module 20 is accommodated in the slot 120, the power connector 122 is electrically connected to the power connector 22 arranged in the electric storage module 20. The power connector 122 may be configured such that the power connector 22 is attachable and detachable thereto and therefrom.

The power connector 122 is electrically connected to the power connector 144. According to the present embodiment, the power connectors 122 of the plurality of slots 120 are electrically connected to the power connector 144 such that a plurality of electric storage modules 20 electrically connected to the power connectors 122 of the plurality of slots 120 are connected in parallel.

In the present embodiment, the communication connector 124 is configured to be able to transmit and receive signals. For example, when the electric storage module 20 is accommodated in the slot 120, the communication connector 124 is communicably connected to the communication connector 24 arranged in the electric storage module 20. The communication connector 124 may be configured such that the communication connector 24 is attachable and detachable thereto and therefrom. In addition, the communication connector 124 is electrically connected to the communication connector 148.

In the present embodiment, the power conditioner 130 adjusts at least one of input power or output power of the power supply system 100. The power conditioner 130 adjusts, for example, input and output of power between (a) at least one of one or more electric storage modules 20 held in the slot 120 and (b) at least one of the power grid 10, the load apparatus 30, or the photovoltaic apparatus 110.

The power conditioner 130 may adjust a magnitude of the input power by adjusting a magnitude of at least one of input current or input voltage. The power conditioner 130 may adjust a magnitude of the output power by adjusting a magnitude of at least one of output current or output voltage.

In an embodiment, the power conditioner 130 converts a voltage of DC power. In another embodiment, the power conditioner 130 converts a voltage and/or frequency of AC power. In still another embodiment, the power conditioner 130 converts DC power to AC power. In still another embodiment, the power conditioner 130 converts AC power into DC power.

In the present embodiment, the power connector 142 is configured to be able to input and output power. The power connector 142 is configured to be able to input and output power to and from the photovoltaic apparatus 110, for example. The power connector 142 may include a set of power terminals.

In the present embodiment, the power connector 144 is configured to be able to input and output power. The power connector 144 is configured to be able to input and output power to and from each of one or more slots 120, for example. The power connector 144 may include a set of power terminals.

In the present embodiment, the communication connector 148 is configured to be able to transmit and receive signals. Accordingly, for example, the power conditioner 130 can transmit and receive information to and from at least one of (a) the photovoltaic apparatus 110, (b) each of one or more slots 120, or (c) each of one or more electric storage modules 20 held in the one or more slots 120 via the communication connector 148.

In the present embodiment, the power connector 152 is configured to be able to input and output power. The power connector 152 is configured to be able to input and output power to and from the power grid 10, for example. The power connector 152 is configured to be able to supply power to the distribution board 12. The power connector 152 may include a set of power terminals.

In the present embodiment, the power connector 154 is configured to be able to input and output power. The power connector 154 is configured to be able to supply power to the load apparatus 30 electrically connected to the power connector 154, for example. The power connector 154 may include a set of power terminals.

In the present embodiment, the DC/DC converter 160 receives, via the power connector 142, power output by the photovoltaic apparatus 110. The DC/DC converter 160 adjusts the power input from the photovoltaic apparatus 110 to the power conditioner 130. The DC/DC converter 160 may adjust the power input from the photovoltaic apparatus 110, based on an instruction from the input/output control unit 180. For example, the DC/DC converter 160 converts a voltage of DC power input from the photovoltaic apparatus 110. The DC/DC converter 160 may output the converted power to the inverter 170.

In the present embodiment, the inverter 170 receives, via the power connector 144, power output by at least one of one or more slots 120. Accordingly, the electric storage module 20 electrically connected to the above-described at least one slot 120 is discharged. The inverter 170 may adjust the power input from the slot 120, based on an instruction from the input/output control unit 180. For example, the inverter 170 converts a voltage of DC power input from the slot 120.

In the present embodiment, the inverter 170 receives power which is input from the power grid 10 and/or the photovoltaic apparatus 110 to the power conditioner 130. The inverter 170 supplies the power to at least one of one or more slots 120 via the power connector 144. Accordingly, the power is supplied to the electric storage module 20 electrically connected to the above-described at least one slot 120. As a result, the above-described electric storage module 20 is charged. The inverter 170 may adjust the power supplied to the slot 120, based on an instruction from the input/output control unit 180.

In an embodiment, the inverter 170 converts AC power, which is input from the power grid 10, into DC power. The inverter 170 may output the converted DC power to the power connector 144. In another embodiment, the inverter 170 converts DC power, which is received from the DC/DC converter 160 and/or the power connector 144, to AC power. The inverter 170 may adjust a voltage and a frequency of the AC power. The inverter 170 may output the converted AC power to the power grid 10 and/or the distribution board 12 via the switch 172. The inverter 170 may output the converted AC power to the load apparatus 30 via the switch 174. The switch 172 and the switch 174 may operate based on an instruction from the input/output control unit 180. In still another embodiment, the inverter 170 may output DC power, which is received from the DC/DC converter 160, to the power connector 144 without conversion into AC power.

In the present embodiment, for example, the input/output control unit 180 controls at least one of output power or input power of the power supply system 100 or the power conditioner 130. The input/output control unit 180 may control the above-described output power and/or input power by controlling an operation of the power conditioner 130. For example, the input/output control unit 180 controls at least one of an output current or an input current of the power supply system 100 or the power conditioner 130. The input/output control unit 180 may control the above-described output current and/or input current by controlling the operation of the power conditioner 130. Details of the input/output control unit 180 will be described later.

### Specific Configuration of Each Unit of Power Supply System 100

Each unit of the power supply system 100 may be realized by hardware, realized by software, or realized by hardware and software. At least a part of each unit of the power supply system 100 may be realized by a single server, or may be realized by a plurality of servers. At least a part of each unit of the power supply system 100 may be realized on a virtual machine or on a cloud system. At least a part of each unit of the power supply system 100 may be realized by a personal computer or a mobile terminal. Examples of the mobile terminal include a mobile phone, a smartphone, a PDA (registered trademark), a tablet, a notebook computer or a laptop computer, a wearable computer, and the like. Each unit of the power supply system 100 may store information by using a distributed ledger technology such as a blockchain or a distributed network.

When at least some of components constituting the power supply system 100 are realized by software, the components realized by the software may be realized in an information processing apparatus having a general configuration by starting a program that defines an operation related to the components. The above-described information processing apparatus includes, for example, (i) a data processing apparatus having a processor such as a CPU or a GPU, a ROM, a RAM, a communication interface, and the like, (ii) an input apparatus such as a keyboard, a touch panel, a camera, a microphone, various types of sensors, or a GPS receiver, (iii) an output apparatus such as a display apparatus, a speaker, or a vibration apparatus, and (iv) a storage apparatus such as a memory or an HDD (including an external storage apparatus). In the above-described information processing apparatus, the data processing apparatus or the storage apparatus described above may store a program. The above-described program may be stored in a non-transitory computer readable recording medium. The above-described program is executed by the processor to cause the above-described information processing apparatus to execute operations defined by the program.

The program may be stored in a computer readable medium such as a CD-ROM, a DVD-ROM, a memory, or a hard disk, or may be stored in a storage apparatus connected to a network. The program may be installed in a computer constituting at least a part of the power supply system 100, from a computer readable medium or a storage apparatus connected to a network. By executing the program, the computer may function as at least a part of each unit of the power supply system 100. The program for causing the computer to function as at least a part of each unit of the power supply system 100 may include a module that defines an operation of each unit of the power supply system 100. These programs or modules operate on the data processing apparatus, the input apparatus, the output apparatus, the storage apparatus, or the like to cause the computer to function as each unit of the power supply system 100 or cause the computer to execute an information processing method in each unit of the power supply system 100. By the programs being read by the computer, information processing described in the programs functions as a specific means as a result of software related to the program and various types of hardware resources of the power supply system 100 cooperating with each other. Then, by realizing computation or processing of information to meet an intended use of the computer in the present embodiment by the above-described specific means, the power supply system 100 to meet the intended use is constructed.

The above-described information processing method may be, for example, a control method for controlling a power apparatus. For example, the above-described power apparatus is configured such that electric storage apparatuses, which are attachable and detachable, can be connected in parallel. The above-described control method may be a method for controlling at least one of output power or input power of the power apparatus. The above-described control method includes, for example, an upper limit power decision step of deciding an upper limit of a magnitude of at least one of the output power or the input power of the power apparatus. In the above-described control method, the upper limit power decision step includes, for example, a step of deciding the upper limit of the magnitude of the output power of the power apparatus, based on a maximum power supply value which is a maximum value of power which each of one or more first electric storage apparatuses, which are electric storage apparatuses electrically connected to a power terminal of the power apparatus, can supply to the power apparatus, and/or a step of deciding the upper limit of the magnitude of the input power of the power apparatus, based on a maximum power reception value which is a maximum value of power with which each of one or more first electric storage apparatuses can be supplied from the power apparatus.

The power grid 10 may be an example of external electrical equipment. The distribution board 12 may be an example of the external electrical equipment. The electric storage module 20 may be an example of an electric storage apparatus, a first electric storage apparatus, or a second electric storage apparatus. The electric storage module 20 may be an example of a management apparatus. The load apparatus 30 may be an example of the external electrical equipment.

The power supply system 100 may be an example of the power apparatus. The photovoltaic apparatus 110 may be an example of the external electrical equipment. The slot 120 may be an example of a holding unit. The power conditioner 130 may be an example of the power apparatus, a power adjustment apparatus, or a power adjustment unit. The power connector 142 may be an example of the power terminal of the power apparatus. The power connector 144 may be an example of the power terminal of the power apparatus. The power connector 152 may be an example of the power terminal of the power apparatus. The power connector 154 may be an example of the power terminal of the power apparatus.

The DC/DC converter 160 may be an example of the power adjustment unit. The inverter 170 may be an example of the power adjustment unit. The switch 172 may be an example of the power adjustment unit. The switch 174 may be an example of the power adjustment unit. The input/output control unit 180 may be an example of a control apparatus.

The connection module may be an example of the first electric storage apparatus. The power supplied from the power conditioner 130 to the electric storage module 20 may be an example of output power of a power supply apparatus. The power input from the power grid 10 and/or the photovoltaic apparatus 110 to the power conditioner 130 may be an example of input power of the power supply apparatus.

### Example of Another Embodiment

In the present embodiment, a case where the power supply system 100 is a stationary power supply system is used as an example to describe details of the power supply system 100. However, the power supply system 100 is not limited to the present embodiment. In another embodiment, the power supply system 100 is mounted on electrical equipment, a transportation apparatus, or the like. In this case, the power supply system 100 includes, for example, one or more slots 120 and the power conditioner 130 or a part of the power conditioner 130.

The electrical equipment is only required to operate using power, and details thereof are not particularly limited. The transportation apparatus transports people and/or articles. The transportation apparatus may utilize power to transport people and/or articles.

Examples of the transportation apparatus include a movable body, work machine, and the like. Examples of the movable body include a vehicle, a marine vessel, a flight vehicle, and the like. Examples of the marine vessel include a ship, a hovercraft, a water bike, a submarine, a submersible craft, an underwater scooter, and the like. Examples of the flight vehicle include an airplane, an air ship or a balloon, a hot-air balloon, a helicopter, a drone, and the like. Examples of the work machine include a forklift, a crane, an elevator, an escalator, a conveyor, and the like.

In the present embodiment, a case where the input/output control unit 180 collects information regarding a battery characteristic of the electric storage unit included in the electric storage module 20, and transmits the collected information to external equipment is used as an example to describe details of the power supply system 100. However, the power supply system 100 is not limited to the present embodiment. In another embodiment, the electric storage module 20 may collect the information regarding the battery characteristic of the electric storage unit included in the electric storage module 20, and transmit the collected information to the external equipment.

In the present embodiment, a case where the power generated by the photovoltaic apparatus 110 is supplied to the power conditioner 130 is used as an example to describe details of the power supply system 100. However, the power supply system 100 is not limited to the present embodiment. In another embodiment, the power supply system 100 may include any type of power generator and may not include a power generator. Examples of the power generator include a power generator using renewable energy or natural energy, a fuel cell, and the like.

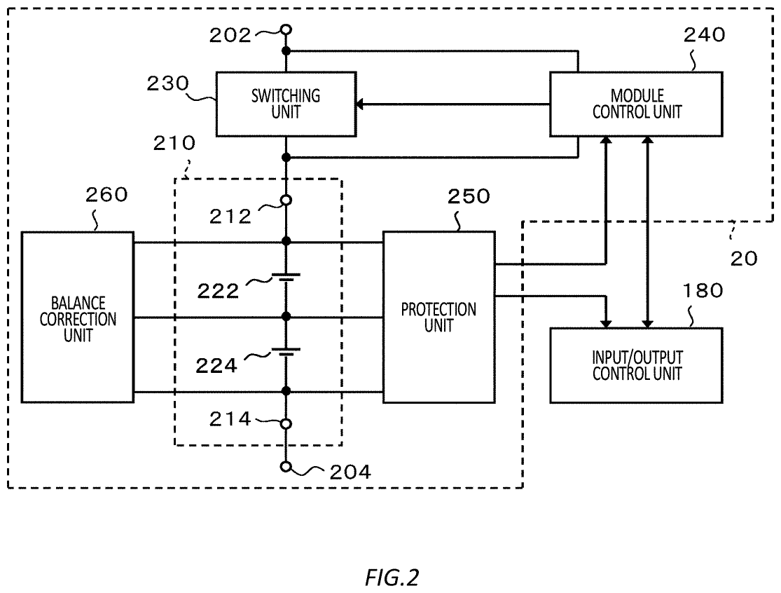

FIG. 2 schematically illustrates an example of a system configuration of the electric storage module 20. In the present embodiment, the electric storage module 20 includes a positive electrode terminal 202 and a negative electrode terminal 204. In addition, the electric storage module 20 includes an electric storage unit 210 having a positive electrode terminal 212 and a negative electrode terminal 214, and a switching unit 230. In the present embodiment, the electric storage unit 210 includes an electric storage cell 222 and an electric storage cell 224. In the present embodiment, the electric storage module 20 further includes a module control unit 240, a protection unit 250, and a balance correction unit 260.

An impedance of the electric storage unit 210 may be equal to or less than 1 Ω or equal to or less than 100 mΩ or less. The impedance of the electric storage unit 210 may be equal to or less than 10 mΩ, equal to or less than 1 mΩ, equal to or less than 0.8 mmΩ, or equal to or less than 0.5 mΩ. The impedance of the electric storage unit 210 may be equal to or greater than 0.1 mΩ. The impedance of the electric storage unit 210 may be equal to or greater than 0.1 mΩ and equal to or less than 1 Ω, may be equal to or greater than 0.1 mΩ and equal to or less than 100 mΩ, may be equal to or greater than 0.1 mΩ and equal to or less than 10 mΩ, or may be equal to or greater than 0.1 mΩ and equal to or less than 1 mΩ.

According to the present embodiment, the switching unit 230 is arranged between the electric storage unit 210 and the power connector 122. In addition, as described later, if an inter-terminal voltage of the switching unit 230 satisfies a predetermined condition, the switching unit 230 electrically connects the electric storage unit 210 and the power connector 122. On the other hand, if the inter-terminal voltage of the switching unit 230 does not satisfy the predetermined condition, the switching unit 230 electrically disconnects the electric storage unit 210 from the power connector 122.

Accordingly, for example, processing for, when one of the plurality of electric storage modules 20 connected in parallel is replaced, matching a voltage of the electric storage module 20 newly added to the power supply system 100 with a voltage of another electric storage module 20 attached to the power supply system 100 with high accuracy can be omitted. As a result, for example, even when the impedance of the electric storage unit 210 is small, the user of the power supply system 100 can easily and quickly replace the electric storage module 20.

In the present embodiment, the electric storage cell 222 and the electric storage cell 224 are connected in series. The electric storage cell 222 and the electric storage cell 224 may be secondary batteries or capacitors. At least one of the electric storage cell 222 or the electric storage cell 224 may further include a plurality of electric storage cells electrically connected in series, in parallel, or in a matrix inside the electric storage cell.

Any type of battery is used as the electric storage cell 222 and the electric storage cell 224. In an embodiment, each of the electric storage cell 222 and the electric storage cell 224 is constituted by a secondary battery of a type capable of supporting trickle charge. In another embodiment, each of the electric storage cell 222 and the electric storage cell 224 is constituted by a secondary battery of a type incapable of supporting trickle charge. At least one of the electric storage cell 222 or the electric storage cell 224 may be a lithium-ion battery.

In general, when a battery system of the secondary battery is represented with a chemical equation in which a continued state of overcharge causes no irreversible change in the battery system in principle, the secondary battery can support trickle charge. On the other hand, when a battery system of the secondary battery is represented with a chemical equation in which a continued state of overcharge causes an irreversible change in the battery system in principle, the secondary battery cannot support trickle charge. Examples of the secondary battery which can support trickle charge include a lead-acid battery, a nickel-hydrogen battery (including an NiMH battery), a nickel-cadmium battery, and the like. Examples of the secondary battery which cannot support trickle charge include a lithium battery, a lithium-ion battery (including a lithium-ion polymer battery and an all solid state battery), and the like.

In the present embodiment, the positive electrode terminal 212 of the electric storage unit 210 is electrically connected to the power connector 122 via the positive electrode terminal 202 and the switching unit 230 of the electric storage module 20. On the other hand, the negative electrode terminal 214 of the electric storage unit 210 is electrically connected to the power connector 122 via the negative electrode terminal 204 of the electric storage module 20.

Note that the electric storage module 20 is not limited to the present embodiment. According to another embodiment, the negative electrode terminal 214 of the electric storage unit 210 is electrically connected to the power connector 122 via the negative electrode terminal 204 and the switching unit 230 of the electric storage module 20. On the other hand, the positive electrode terminal 212 of the electric storage unit 210 is electrically connected to the power connector 122 via the positive electrode terminal 202 of the electric storage module 20.

In the present embodiment, the switching unit 230 is arranged between the power connector 122 and the electric storage unit 210. In the present embodiment, the switching unit 230 switches an electrical connection relationship between the power connector 122 and the electric storage unit 210, based on a voltage difference between the power connector 122 and the electric storage unit 210. For example, the switching unit 230 switches a connection state of the power connector 122 and the electric storage unit 210, based on a signal generated by the module control unit 240. Accordingly, the electric storage unit 210 can be electrically connected to the power connector 122, or the electric storage unit 210 can be electrically disconnected from the power connector 122.

When the electric storage module 20 is attached in the slot 120, the electric storage module 20 may be attached in the slot 120 in a state where the switching unit 230 electrically disconnects the electric storage unit 210 from the power connector 122. Accordingly, breakage or deterioration of the electric storage module 20 can be suppressed.

The switching unit 230 may be realized by hardware, realized by software, or realized by combination of hardware and software. The switching unit 230 may be realized by an analog circuit, a digital circuit, or combination of an analog circuit and a digital circuit.

The switching unit 230 may have one or more elements. The switching unit 230 may include one or more switching elements. Each of the one or more switching elements may be arranged between the positive electrode terminal 202 and the positive electrode terminal 212 or between the negative electrode terminal 204 and the negative electrode terminal 214. Examples of the switching elements can include a relay, a thyristor, a transistor, and the like. The thyristor may be a bidirectional thyristor (may be referred to as a triac). The transistor may be a semiconductor transistor. The semiconductor transistor may be a bipolar transistor or a field effect transistor. The field effect transistor may be a MOSFET.

The switching unit 230 may include one or more DC-DC converters instead of or together with the switching element. The DC-DC converter may be an isolated DC-DC converter. The DC-DC converter may be a unidirectional DC-DC converter or a bidirectional DC-DC converter. The switching unit 230 may include a transformer instead of or together with the switching element.

In the present embodiment, the module control unit 240 manages a state of the electric storage module 20. The module control unit 240 controls an operation of the electric storage module 20.

For example, the module control unit 240 controls a current flowing between the electric storage unit 210 of the electric storage module 20 and the power connector 122. In the present embodiment, if the inter-terminal voltage of the switching unit 230 (a voltage between the positive electrode terminal 202 and the positive electrode terminal 212 in the present embodiment) satisfies a predetermined condition, the module control unit 240 controls the switching unit 230 such that the switching unit 230 electrically connects the electric storage unit 210 and the power connector 122. The switching unit 230 may electrically connect the electric storage unit 210 and the power connector 122 by electrically connecting the electric storage unit 210 and the positive electrode terminal 202.

On the other hand, if the inter-terminal voltage of the switching unit 230 does not satisfy the predetermined condition, the module control unit 240 controls the switching unit 230 such that the switching unit 230 electrically disconnects the electric storage unit 210 from the power connector 122 or disconnects the electric storage unit 210 from the positive electrode terminal 202. The switching unit 230 may electrically disconnect the electric storage unit 210 from the power connector 122 by electrically disconnecting the electric storage unit 210 from the positive electrode terminal 202.

The predetermined condition may be a condition that an absolute value of the inter-terminal voltage of the switching unit 230 is within a predetermined range. The predetermined range may be equal to or lower than 3 V, equal to or lower than 1 V, equal to or lower than 0.1 V, equal to or lower than 10 mV, or equal to or lower than 1 mV. In addition, the predetermined range may be equal to or higher than 0.5 mV or equal to or higher than 1 mV. The predetermined range may be equal to or higher than 0.5 mV and equal to or lower than 3 V. The predetermined range may be equal to or higher than 1 mV and equal to or lower than 3 V, may be equal to or higher than 1 mV and equal to or lower than 1 V, may be equal to or higher than 1 mV and equal to or lower than 0.1 V, may be equal to or higher than 1 mV and equal to or lower than 10 mV, may be equal to or higher than 10 mV and equal to or lower than 1 V, may be equal to or higher than 10 mV and equal to or lower than 0.1 V, or may be equal to or higher than 0.1 V and equal to or lower than 1 V. Note that the inter-terminal voltage of the switching unit 230 may be the voltage between the positive electrode terminal 202 and the positive electrode terminal 212, or may be a voltage between the power connector 122 and the electric storage unit 210.

The predetermined range may be set based on the impedance of the electric storage unit 210. The predetermined range may be set based on a rated current or allowable current of the electric storage unit 210. The predetermined range may be set based on the impedance of the electric storage unit 210 and on the rated current or allowable current of the electric storage unit 210. The predetermined range may be set based on a rated current or allowable current of an element that is included in elements constituting the electric storage module 20 and has a lowest rated current or allowable current. The predetermined range may be set based on the impedance of the electric storage module 20 and on the rated current or allowable current of the element that is included in the elements constituting the electric storage module 20 and has the lowest rated current or allowable current.

Accordingly, when the electric storage module 20 attached to the power supply system 100 is replaced, until a voltage difference between the electric storage module 20 newly attached to the power supply system 100 and another electric storage module 20 already attached to the power supply system 100 falls within a predetermined range, the electric storage unit 210 of the newly attached electric storage module 20 is electrically disconnected from the power connector 122 of the slot 120 to which the above-described electric storage module 20 is attached. Thereafter, when the above-described voltage difference falls within the predetermined range, the electric storage unit 210 of the newly attached electric storage module 20 and the above-described power connector 122 are electrically connected. According to the present embodiment, since the electric storage module 20 and the slot 120 are automatically electrically connected, the user of the power supply system 100 can easily and quickly replace the electric storage module 20.

In the present embodiment, the module control unit 240 may receive, from the input/output control unit 180, a signal indicating that an inter-terminal voltage of the electric storage module 20 in which the module control unit 240 is incorporated is lower than an inter-terminal voltage of another electric storage modules 20. If the module control unit 240 receives the above-described signal when the power supply system 100 shifts to a state of charge, the module control unit 240 controls the switching unit 230 such that the switching unit 230 electrically connects the electric storage unit 210 and the power connector 122. Accordingly, the plurality of electric storage modules 20 which are connected in parallel to each other can be efficiently charged.

In the present embodiment, the module control unit 240 may receive, from the input/output control unit 180, a signal indicating that the inter-terminal voltage of the electric storage module 20 in which the module control unit 240 is incorporated is higher than the inter-terminal voltage of another electric storage modules 20. If the module control unit 240 receives the above-described signal when the power supply system 100 shifts to a state of discharge, the module control unit 240 controls the switching unit 230 such that the switching unit 230 electrically connects the electric storage unit 210 and the power connector 122. Accordingly, the plurality of electric storage modules 20 which are connected in parallel to each other can be efficiently discharged.

In the present embodiment, the module control unit 240 receives, from the protection unit 250, a signal indicating that an inter-terminal voltage of the electric storage cell 222 or an inter-terminal voltage of the electric storage cell 224 is not within in a predetermined range. When the module control unit 240 receives the signal, the module control unit 240 controls the switching unit 230 such that the switching unit 230 electrically disconnects the electric storage unit 210 from the power connector 122. Accordingly, deterioration or damage of the electric storage unit 210 due to overcharge or over discharge can be suppressed.

In the present embodiment, the module control unit 240 accepts a user operation and receives, from the user, an instruction for turning on or turning off the switching unit 230. When the module control unit 240 receives the instruction from the user, the module control unit 240 controls the switching unit 230 in accordance with the instruction.

In the present embodiment, the module control unit 240 may acquire information regarding a battery characteristic of the electric storage unit 210. The module control unit 240 may output, to external equipment, the information regarding the battery characteristic of the electric storage unit 210. Accordingly, the external equipment can use the information regarding the battery characteristic of the electric storage unit 210. Examples of the external equipment include the load apparatus 30, the power conditioner 130, and the like. The external equipment may be an output apparatus that outputs information to the user.

The module control unit 240 may be realized by hardware or realized by software. In addition, the module control unit 240 may be realized by combination of hardware and software. In an embodiment, the module control unit 240 may be realized by an analog circuit, a digital circuit, or combination of an analog circuit and a digital circuit. In another embodiment, in a general information processing apparatus provided with a data processing apparatus and the like having a CPU, a ROM, a RAM, a communication interface, and the like, the module control unit 240 may be realized by executing a program for controlling the module control unit 240.

The programs installed into a computer to cause the computer to function as part of the module control unit 240 according to the present embodiment may include modules that define operations of the respective units of the module control unit 240. These programs or modules cooperate with CPU or the like to cause the computer to function as the respective units of the module control unit 240.

By being read by the computer, the information processing described in these programs functions as specific means as a result of the software and the above-described various types of hardware resources cooperating with each other. By realizing computation or processing of information to meet the intended use of the computer in the present embodiment by these specific means, a specific apparatus to meet the intended use can be constructed. The programs may be stored on a computer readable medium or a storage apparatus connected to a network. The computer readable medium may be a non-transitory computer readable medium.

The protection unit 250 protects the electric storage unit 210. In the present embodiment, the protection unit 250 protects the electric storage unit 210 from overcharge and over discharge. When the protection unit 250 detects that the inter-terminal voltage of the electric storage cell 222 or the inter-terminal voltage of the electric storage cell 224 is not within the predetermined range, the protection unit 250 transmits, to the module control unit 240, a signal indicating the content of the detection. The protection unit 250 may transmit, to the input/output control unit 180, the information regarding an inter-terminal voltage of the electric storage unit 210. The protection unit 250 may be realized by hardware, realized by software, or realized by combination of hardware and software. The protection unit 250 may be realized by an analog circuit, a digital circuit, or combination of an analog circuit and a digital circuit.

The balance correction unit 260 equalizes voltages of the plurality of electric storage cells. An operating principle of the balance correction unit 260 is not particularly limited, and any balance correction apparatus can be used. When the electric storage unit 210 includes three or more electric storage cells, the electric storage module 20 may include a plurality of balance correction units 260. In an embodiment, when the electric storage unit 210 includes n (n is an integer equal to or greater than 2) electric storage cells, the electric storage module 20 includes n−1 balance correction unit(s) 260. For example, when the balance correction unit 260 is a balance correction apparatus of an active balancing type or a converter type, the electric storage module 20 includes n−1 balance correction unit(s) 260. In another embodiment, when the electric storage unit 210 includes (n is an integer equal to or greater than 2) electric storage cells, the electric storage module 20 includes n balance correction units 260. For example, when the balance correction unit 260 is a balance correction apparatus of a passive balance type, the electric storage module 20 includes n balance correction units 260.

The balance correction unit 260 may be realized by hardware, realized by software, or realized by combination of hardware and software. The balance correction unit 260 may be realized by an analog circuit, a digital circuit, or combination of an analog circuit and a digital circuit. In an embodiment, the balance correction unit 260 is an active-type balance correction apparatus. The active-type balance correction unit may be a balance correction unit which transfers electric charges between two electric storage cells via an inductor as described in Japanese Patent Application Publication No. 2006-067742 or may be a balance correction unit which transfers electric charges via a capacitor as described in Japanese Patent Application Publication No. 2012-210109. In another embodiment, the balance correction unit 260 may be a passive-type balance correction apparatus. The passive-type balance correction apparatus releases extra electric charges by using an external resistor, for example.

The module control unit 240 may be an example of the management apparatus. The electric storage module 20 in which the electric storage unit 210 is electrically disconnected from the power connector 122 by the switching unit 230 may be an example of the second electric storage apparatus.

### Example of Another Embodiment

In the present embodiment, a case has been described in which the electric storage unit 210 includes the two electric storage cells connected in series. However, the electric storage unit 210 is not limited to the present embodiment. In another embodiment, the electric storage unit 210 may also include three or more electric storage cells connected in series. In addition, the electric storage unit 210 may include a plurality of electric storage cells connected in parallel or may include a plurality of electric storage cells connected in a matrix.

In the present embodiment, a case where the switching unit 230 is arranged inside the electric storage module 20 is used as an example to describe details of the power supply system 100. However, the power supply system 100 is not limited to the present embodiment. In another embodiment, the switching unit 230 may be arranged in the slot 120. The switching unit 230 may be arranged between the power connector 122 and the power connector 144.

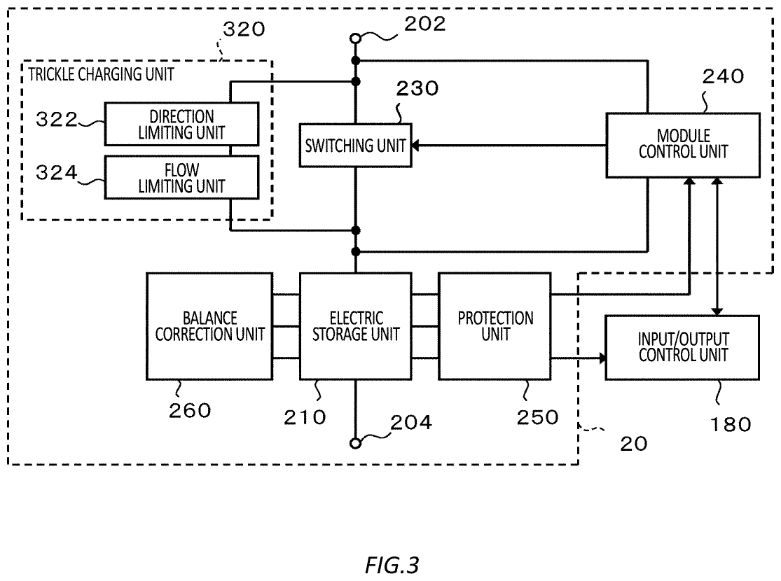

FIG. 3 schematically illustrates an example of the system configuration of the electric storage module 20. In the present embodiment, the electric storage module 20 is different from the electric storage module 20 described in connection with FIG. 2 in that each of a plurality of electric storage cells constituting the electric storage unit 210 is constituted by a secondary battery of a type capable of supporting trickle charge, and the electric storage module 20 includes a trickle charging unit 320. In the present embodiment, components other than the above-described difference may have features similar to those of corresponding components of the electric storage module 20 described in connection with FIG. 2.

In the present embodiment, the trickle charging unit 320 includes a direction limiting unit 322 and a flow limiting unit 324. The trickle charging unit 320 is connected in parallel with the switching unit 230 between the power connector 122 of the slot 120 and the electric storage unit 210 of the electric storage module 20. The trickle charging unit 320 may have a higher resistance than the switching unit 230 during an on operation. In this case, a resistance value when a current flows between the power connector 122 and the electric storage unit 210 via the trickle charging unit 320 is lower than a resistance value of the switching unit 230 when a current leaks through the switching unit 230 during an off operation.

In the present embodiment, the trickle charging unit 320 allows a current to pass in a direction from the power connector 122 toward the electric storage unit 210. On the other hand, the trickle charging unit 320 suppresses passage of the current in a direction from the electric storage unit 210 toward the power connector 122. For example, the trickle charging unit 320 does not allow the current to pass in the direction from the electric storage unit 210 toward the power connector 122.

In the present embodiment, the flow limiting unit 324 limits an amount of current flowing through the trickle charging unit 320. The flow limiting unit 324 may have a higher resistance than the switching unit 230. The flow limiting unit 324 may have at least one of a fixed resistor, a variable resistor, a constant current circuit, and a constant power circuit. The flow limiting unit 324 may include a PTC thermistor. When a current flows through the flow limiting unit 324 while trickle charging of the electric storage unit 210 is performed, the flow limiting unit 324 may generate heat. Even in this case, according to the present embodiment, since the flow limiting unit 324 includes the PTC thermistor, when a temperature of the flow limiting unit 324 increases, the amount of current flowing through the flow limiting unit 324 decreases. Accordingly, while the trickle charging of the electric storage unit 210 is performed, the temperature of the flow limiting unit 324 can be maintained within a predetermined numerical range.

In the present embodiment, the direction limiting unit 322 is connected in series with the flow limiting unit 324. The direction limiting unit 322 allows a current to pass in the direction from the power connector 122 toward the electric storage unit 210. On the other hand, the direction limiting unit 322 does not allow the current to pass in the direction from the electric storage unit 210 toward the power connector 122. The direction limiting unit 322 may include a diode. The above-described diode may be arranged such that the direction from the power connector 122 toward the electric storage unit 210 is a forward direction.

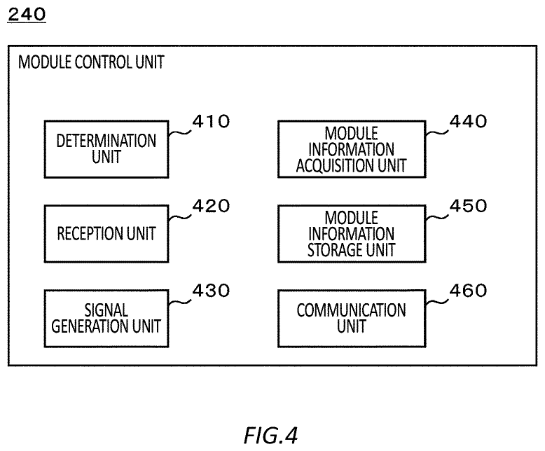

FIG. 4 schematically illustrates an example of a system configuration of the module control unit 240. In the present embodiment, the module control unit 240 includes a determination unit 410, a reception unit 420, and a signal generation unit 430. The module control unit 240 may include a module information acquisition unit 440, a module information storage unit 450, and a communication unit 460.

In the present embodiment, the determination unit 410 determines whether or not the inter-terminal voltage of the switching unit 230 is within a predetermined range. The determination unit 410 transmits, to the signal generation unit 430, a signal indicating a determination result. The determination unit 410 may be any comparator or comparison circuit. The determination unit 410 may be a window comparator.

In the present embodiment, the reception unit 420 receives at least one of a signal from the input/output control unit 180, a signal from the protection unit 250, or an instruction from the user. The reception unit 420 transmits, to the signal generation unit 430, a signal corresponding to the received information.

### Control Signal of Switching Unit 230

In the present embodiment, the signal generation unit 430 receives a signal from at least one of the determination unit 410 or the reception unit 420. The signal generation unit 430 generates a signal (may be referred to as a control signal of the switching unit 230) for controlling the switching unit 230, based on the received information. Accordingly, the signal generation unit 430 can decide to electrically disconnect the electric storage module 20 from the power connector 122 of the slot 120. Similarly, the signal generation unit 430 can decide to electrically connect the electric storage module 20 and the power connector 122 of the slot 120. The signal generation unit 430 may transmit the generated control signal to the switching unit 230.

In an embodiment, if the determination unit 410 determines that the inter-terminal voltage of the switching unit 230 is within the predetermined range, the signal generation unit 430 generates a signal for turning on the switching element of the switching unit 230. In another embodiment, if the determination unit 410 determines that the inter-terminal voltage of the switching unit 230 is not within the predetermined range, the signal generation unit 430 generates a signal for turning off the switching element of the switching unit 230.

The signal generation unit 430 may generate or transmit a signal after a predetermined time has elapsed since the determination unit 410 determines whether or not the inter-terminal voltage of the switching unit 230 is within the predetermined range. Accordingly, malfunction due to noise or the like can be prevented. In addition, it is possible to prevent the electric storage unit 210 and the power connector 122 from being electrically connected immediately after the electric storage module 20 is attached in the slot 120.

In the present embodiment, the signal generation unit 430 generates a signal for controlling the switching element of the switching unit 230, based on the signal received by the reception unit 420. In an embodiment, when the reception unit 420 receives, from the input/output control unit 180, a signal for turning on the switching element of the switching unit 230, the signal generation unit 430 generates a signal for turning on the switching element of the switching unit 230.

In another embodiment, when the reception unit 420 receives, from the protection unit 250, a signal for turning off the switching element of the switching unit 230, the signal generation unit 430 generates a signal for turning off the switching element of the switching unit 230. In still another embodiment, when the reception unit 420 accepts an instruction f from the user, the signal generation unit 430 generates a signal for causing the switching element of the switching unit 230 to operate as instructed by the user.

### Advance Notice Signal

According to the present embodiment, if the determination unit 410 determines that the inter-terminal voltage of the switching unit 230 is within the predetermined range, the signal generation unit 430 generates a signal for giving advance notice of electrical disconnection between the electric storage unit 210 of the electric storage module 20 and the power connector 122 of the slot 120 (may be referred to as an advance notice signal). The advance notice signal may be a signal for giving advance notice of a decrease in a number of the electric storage modules 20 electrically connected to one or more power connectors 122 arranged in the power supply system 100. The signal generation unit 430 may transmit the advance notice signal to the input/output control unit 180 via the communication unit 460.

When a predetermined third condition is satisfied after the communication unit 460 transmits the advance notice signal, the signal generation unit 430 may decide to electrically disconnect the power connector 122 of the slot 120 from the electric storage module 20. Examples of the third condition include (i) a condition that a predetermined time has elapsed since the communication unit 460 outputs the advance notice signal, or (ii) a condition that the module control unit 240 receives, from the input/output control unit 180, a signal indicating that processing for reducing the output current of the power supply system 100 has started or that the processing has been completed after the communication unit 460 outputs the advance notice signal.

After the signal generation unit 430 decides to electrically disconnect the power connector 122 of the slot 120 from the electric storage module 20, the signal generation unit 430 generates a signal for turning off the switching element of the switching unit 230. The signal generation unit 430 transmits the above-described signal to the switching unit 230. Accordingly, the switching unit 230 electrically disconnects the power connector 122 of the slot 120 from the electric storage module 20.

In the present embodiment, the module information acquisition unit 440 acquires the information regarding the battery characteristic of the electric storage unit 210. The module information acquisition unit 440 may also acquire the information regarding the battery characteristic of the electric storage unit 210 by measuring the battery characteristic of the electric storage unit 210. The module information acquisition unit 440 may also acquire the information regarding the battery characteristic of the electric storage unit 210, the information being input by a manufacturer, a seller, or the like at time of shipping, testing, or selling.

The module information acquisition unit 440 may store the information regarding the battery characteristic of the electric storage unit 210 in the module information storage unit 450. Although a specific configuration of the module information acquisition unit 440 is not particularly limited, the module information acquisition unit 440 may be a controller that controls reading data from and writing data into the module information storage unit 450. In the present embodiment, the module information storage unit 450 stores the information regarding the battery characteristic of the electric storage unit 210, the information being acquired by the module information acquisition unit 440.

In the present embodiment, the communication unit 460 transmits and receives various types of information to and from the input/output control unit 180. For example, the communication unit 460 transmits, to the input/output control unit 180, the advance notice signal generated by the signal generation unit 430. The communication unit 460 may receive, from the input/output control unit 180, the signal indicating that the processing for reducing the output current of the power supply system 100 has started based on the advance notice signal, or the signal indicating that the processing has been completed.

For example, the communication unit 460 transmits, to the input/output control unit 180, the information regarding the battery characteristic of the electric storage unit 210, the information being acquired by the module information acquisition unit 440. The communication unit 460 may transmit, to the external equipment, the information regarding the battery characteristic of the electric storage unit 210, the information being acquired by the module information acquisition unit 440. The communication unit 460 may transmit the information regarding the battery characteristic of the electric storage unit 210 in response to a request from the external equipment, or may transmit the information regarding the battery characteristic of the electric storage unit 210 at a predetermined timing. The communication unit 460 may refer to the module information storage unit 450 to transmit, to the input/output control unit 180 or the external equipment, the information regarding the battery characteristic of the electric storage unit 210.

The signal generation unit 430 may be an example of the management apparatus, a transmission unit, or a disconnection unit. The communication unit 460 may be an example of the transmission unit.

### Example of Another Embodiment

In the present embodiment, a case where, when the determination unit 410 determines that the inter-terminal voltage of the switching unit 230 is within the predetermined range, the signal generation unit 430 generates the advance notice signal and the communication unit 460 transmits the advance notice signal to the input/output control unit 180 is used as an example to describe details of the power supply system 100. However, the power supply system 100 is not limited to the present embodiment.

In another embodiment, when the voltage difference between the electric storage unit 210 of the electric storage module 20 and the power connector 122 of the slot 120 meets a predetermined second condition during a period in which the power supply system 100 to which the electric storage module 20 is attached outputs power, the signal generation unit 430 generates the advance notice signal. In addition, the communication unit 460 transmits the advance notice signal to the input/output control unit 180. Examples of the above-described second condition include a condition that the above-described voltage difference is less than a predetermined value or a condition that an absolute value of the above-described voltage difference is less than a predetermined value.

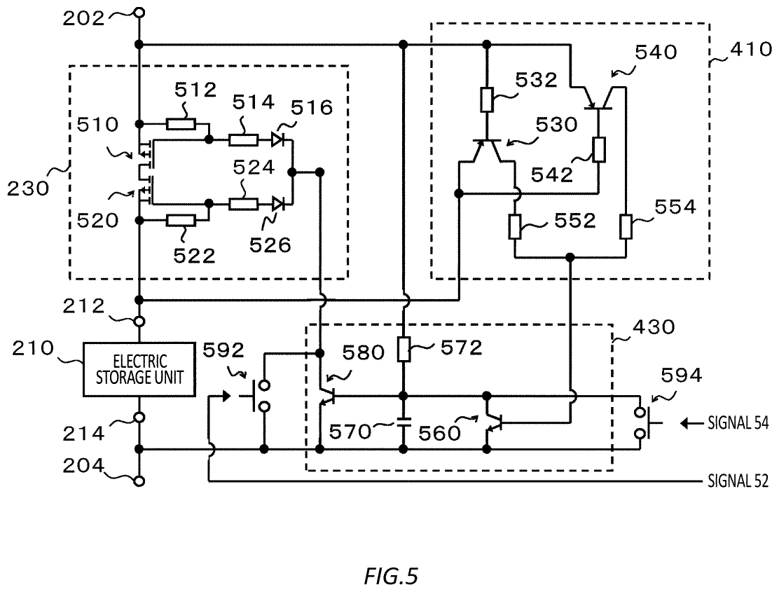

FIG. 5 schematically illustrates an example of a circuit configuration of the electric storage module 20. Note that, for the purpose of simplifying the description, the protection unit 250 and the wiring related to the protection unit 250 are not illustrated in FIG. 5.

In the present embodiment, the switching unit 230 includes a transistor 510, a resistor 512, a resistor 514, a diode 516, a transistor 520, a resistor 522, a resistor 524, and a diode 526. The transistor 510 and the transistor 520 may be examples of the switching element. In the present embodiment, a case is described in which the transistor 510 and the transistor 520 are used as the switching elements of the switching unit 230. However, the switching element of the switching unit 230 is not limited to the present embodiment. In another embodiment, a single switching element may be used as the switching element of the switching unit 230.

In the present embodiment, the module control unit 240 includes the determination unit 410, the signal generation unit 430, a switch 592, and a switch 594. In the present embodiment, the determination unit 410 includes a transistor 530, a resistor 532, a transistor 540, a resistor 542, a resistor 552, and a resistor 554. The signal generation unit 430 includes a transistor 560, a capacitor 570, a resistor 572, and a transistor 580. The switch 592 and the switch 594 may be examples of the reception unit 420.

Then, details of each unit of the switching unit 230 and the module control unit 240 will be described. In the switching unit 230 of the present embodiment, the transistor 510 is a MOSFET, and even when the transistor 510 is in an off state, the current may flow from the positive electrode terminal 212 toward the positive electrode terminal 202 due to a parasitic diode (not illustrated) equivalently formed between a source and a drain of the transistor 510. Similarly, the transistor 520 is a MOSFET, and even when the transistor 520 is in the off state, the current may flow from the positive electrode terminal 202 toward the positive electrode terminal 212 due to a parasitic diode (not illustrated) equivalently formed between a source and a drain of the transistor 520.

In the present embodiment, the transistor 510 and the transistor 520 are set to the off state at an initial setting. When the transistor 580 is turned on during charging of the power supply system 100, the current flows from the positive electrode terminal 202 toward the negative electrode terminal 204 via the resistor 512, the resistor 514, and the transistor 580. As a result, a voltage is applied to a gate of the transistor 510, and the transistor 510 is turned on. Accordingly, the current is allowed to flow from the positive electrode terminal 202 toward the positive electrode terminal 212 via the parasitic diode equivalently formed between the source and the drain of the transistor 520.

On the other hand, when the transistor 580 is turned on during discharging of the power supply system 100, the current flows from the positive electrode terminal 212 toward the negative electrode terminal 214 via the resistor 522, the resistor 524, and the transistor 580. As a result, a voltage is applied to a gate of the transistor 520, and the transistor 520 is turned on. Accordingly, a current is allowed to flow from the positive electrode terminal 212 toward the positive electrode terminal 202 via the parasitic diode equivalently formed between the source and the drain of the transistor 510.

The voltage that is applied to the gate of the transistor 510 or the gate of the transistor 520 with the transistor 580 turned on may be an example of the signal for turning on the switching element of the switching unit 230. Similarly, the voltage that is applied to the gate of the transistor 510 or the gate of the transistor 520 with the transistor 580 turned off may be an example of the signal for turning off the switching element of the switching unit 230.

In the present embodiment, values of the resistor 512 and the resistor 514 are set such that the transistor 510 can be reliably turned on and off in a power saving manner. In addition, values of the resistor 522 and the resistor 524 are set such that the transistor 520 can be reliably turned on and off in a power saving manner.

In the present embodiment, the diode 516 is arranged between the resistor 514 and the resistor 524. The diode 516 allows the current to pass in a direction from the resistor 514 toward the resistor 524, but does not allow a current to pass in a direction from the resistor 524 toward the resistor 514. By providing the diode 516, the current can be prevented from leaking from the positive electrode terminal 212 to the positive electrode terminal 202 through a route of the resistor 522, the resistor 524, the resistor 514, and the resistor 512 when the switching unit 230 electrically disconnects the positive electrode terminal 202 from the positive electrode terminal 212.

In the present embodiment, the diode 526 is arranged between the resistor 514 and the resistor 524. The diode 526 allows the current to pass in the direction from the resistor 524 toward the resistor 514, but does not allow the current to pass in the direction from the resistor 514 toward the resistor 524. By providing the diode 526, the current can be prevented from leaking from the positive electrode terminal 202 to the positive electrode terminal 212 through a route of the resistor 512, the resistor 514, the resistor 524, and the resistor 522 when the switching unit 230 electrically disconnects the positive electrode terminal 202 from the positive electrode terminal 212.

In the module control unit 240 of the present embodiment, the transistor 530 and the transistor 540 of the determination unit 410 are set to the off state at the initial setting. In addition, the transistor 560 and the transistor 580 of the signal generation unit 430 are set to the off state in the initial setting.

According to the present embodiment, when the inter-terminal voltage of the switching unit 230 is lower than a first value, which is predetermined such that the positive electrode terminal 202 side is set as positive, a value of the resistor 532 is set such that the transistor 530 is turned on. The value of the resistor 532 is preferably set such that the current that leaks when the switching unit 230 is in the off state is extremely small. In addition, a value of the resistor 542 is set such that the transistor 540 is turned on when the inter-terminal voltage of the switching unit 230 is higher than a predetermined second value. The value of the resistor 542 is preferably set such that the current that leaks when the switching unit 230 is in the off state is extremely small. Note that, according to the present embodiment, the inter-terminal voltage of the switching unit 230 is equal to a voltage difference between the positive electrode terminal 202 and the positive electrode terminal 212.

When the inter-terminal voltage of the switching unit 230 is lower than the predetermined first value, the transistor 530 is turned on, the voltage is applied from the electric storage unit 210 to a base of the transistor 560 via the positive electrode terminal 212, the transistor 530, and the resistor 552, and the transistor 560 is turned on. Although the voltage from the positive electrode terminal 202 is applied to the base of the transistor 580, the transistor 580 is inhibited from turning on while the transistor 560 is turned on. As a result, the transistor 580 is turned off.

On the other hand, when the inter-terminal voltage of the switching unit 230 is higher than the predetermined second value, the transistor 540 is turned on, the voltage is applied from the positive electrode terminal 202 to the base of the transistor 560 via the transistor 540 and the resistor 554, and the transistor 560 is turned on. As a result, the transistor 580 is turned off.

In the present embodiment, a value of the resistor 552 is set such that power consumption can be reduced within a range in which the transistor 560 can be turned on when the transistor 530 is in an on state. A value of the resistor 554 is set such that the power consumption can be reduced within a range in which the transistor 560 can be turned on when the transistor 540 is in the on state.

A capacity of the capacitor 570 is set such that the transistor 560 is turned on before the voltage from the positive electrode terminal 202 is applied to the base of the transistor 580 and the transistor 580 is turned on. Accordingly, the signal generation unit 430 can generate a signal after a predetermined time has elapsed since the determination unit 410 determined whether or not the inter-terminal voltage of the switching element is within the predetermined range.

In contrast, when the inter-terminal voltage of the switching unit 230 is within a range determined by the first value and the second value, the transistor 530 and the transistor 540 remain off, and the transistor 560 also remains off. Therefore, the voltage is applied from the positive electrode terminal 202 to the base of the transistor 580 via the resistor 572, and the transistor 580 is turned on.

The switch 592 and the switch 594 may be manual switches or switching elements such as relays, thyristors, and transistors. A signal 52 indicating that the switching unit 230 is turned on may be input to the switch 592. A signal 54 indicating that the switching unit 230 is turned off may be input to the switch 594.

When the switch 592 is turned on, the switching unit 230 can be turned on regardless of whether the transistor 580 is turned on or turned off. When the switch 594 is turned on, the transistor 580 can be turned off regardless of whether the transistor 560 is turned on or turned off. As a result, the switching unit 230 can be turned off.

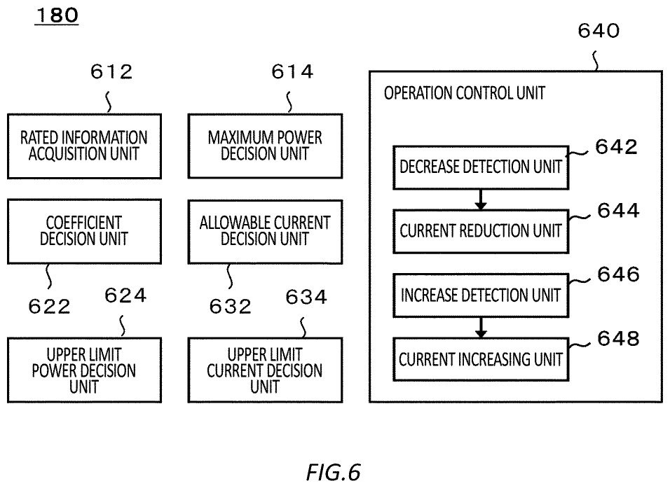

FIG. 6 schematically illustrates an example of a system configuration of the input/output control unit 180. In the present embodiment, the input/output control unit 180 includes a rated information acquisition unit 612, a maximum power decision unit 614, a coefficient decision unit 622, an upper limit power decision unit 624, an allowable current decision unit 632, an upper limit current decision unit 634, and an operation control unit 640. In the present embodiment, the operation control unit 640 includes a decrease detection unit 642, a current reduction unit 644, an increase detection unit 646, and a current increasing unit 648.

In the present embodiment, the rated information acquisition unit 612 acquires information indicating various rated values related to each of the one or more connection modules described above (may be referred to as rated information). The rated information acquisition unit 612 acquires the rated information stored in the module information storage unit 450 from the module control unit 240, for example. Examples of the above-described rated values include at least one value of a rated output power, a rated output current, a rated output voltage, a rated input power, a rated input current, or a rated input voltage of the electric storage unit 210. Other examples of the above-described rated values include at least one value of a rated output power, a rated output current, a rated output voltage, a rated input power, a rated input current, or a rated input voltage of the switching unit 230.

In the present embodiment, the maximum power decision unit 614 decides a maximum value of power which each of the one or more connection modules described above can supply to the power supply system 100 (may be referred to as a maximum power supply value). The maximum power decision unit 614 decides the maximum power supply value based on, for example, a smaller value of (a) the rated output power of the electric storage unit 210 of each of one or more connection modules and (b) the rated output power of the switching unit 230 of each of the one or more connection modules. The maximum power decision unit 614 may decide the above-described smaller value as the maximum power supply value.

The maximum power decision unit 614 may decide the maximum power supply value based on a smaller value of (a) the rated output current of the electric storage unit 210 of each of one or more connection modules and (b) the rated output current of the switching unit 230 corresponding to each of the one or more connection modules. For example, the maximum power decision unit 614 decides the maximum power supply value based on a voltage at a specific time and a value of the above-described rated output current.

As described above, the maximum value of the power which can be supplied to the power supply system 100 is decided by a maximum value of a current which can be supplied to the power supply system 100. In this regard, in another embodiment, the maximum power decision unit 614 may derive, as the maximum power supply value, the maximum value of the current which can be supplied to the power supply system 100. In this case, the maximum power decision unit 614 may decide the above-described smaller value as the maximum power supply value.

In the present embodiment, the maximum power decision unit 614 decides a maximum value of power with which each of the one or more connection modules described above can be supplied from the power supply system 100 (may be referred to as a maximum power reception value). The maximum power decision unit 614 decides the maximum power reception value based on, for example, a smaller value of (a) the rated input power of the electric storage unit 210 of each of one or more connection modules and (b) the rated input power of the switching unit 230 corresponding to each of the one or more connection modules. The maximum power decision unit 614 may decide the above-described smaller value as the maximum power reception value.

The maximum power decision unit 614 may decide the maximum power reception value based on, for example, a smaller value of (a) the rated input current of the electric storage unit 210 of each of one or more connection modules and (b) the rated input current of the switching unit 230 corresponding to each of the one or more connection modules. The maximum power decision unit 614 may decide the above-described smaller value as the maximum power reception value.

In the present embodiment, the coefficient decision unit 622 decides various coefficients used to decide an upper limit of a magnitude of the output power and/or the input power of the power supply system 100. For example, the coefficient decision unit 622 decides the above-described coefficient for each of the one or more connection modules described above. In an embodiment, the coefficient decision unit 622 decides a coefficient used to decide the upper limit of the magnitude of the output power of the power supply system 100 (may be referred to as a power supply coefficient). In another embodiment, the coefficient decision unit 622 decides a coefficient used to decide the upper limit of the magnitude of the input power of the power supply system 100 (may be referred to as a power reception coefficient).

The coefficient decision unit 622 may decide the above-described coefficient to be applied to each connection module, based on, for example, at least one of (i) an equivalent series resistance, (ii) a slope of an SOC-OCV curve, or (iii) an SOH of each connection module. The above-described coefficient may be a positive number equal to or less than 1.

The coefficient decision unit 622 may decide the above-described coefficient such that the above-described coefficient applied to the electric storage module 20 decreases as the equivalent series resistance of the electric storage module 20 increases. The above-described coefficient may be a reciprocal of the equivalent series resistance of the electric storage module 20, or may be a product of the reciprocal and a predetermined reference value related to the equivalent series resistance.

The coefficient decision unit 622 may decide the above-described coefficient such that the above-described coefficient applied to the electric storage module 20 decreases as the slope of the SOC-OCV curve of the electric storage module 20 at a point corresponding to a present value of a voltage (specifically, an OCV) of the electric storage module 20 on the curve increases. The above-described coefficient may be a reciprocal of the above-described slope, or may be a product of the reciprocal and a predetermined reference value related to the slope.

The coefficient decision unit 622 may decide the above-described coefficient such that the above-described coefficient applied to electric storage module 20 decreases as the SOH of the electric storage module 20 decreases. The above-described coefficient may be the SOH of the electric storage module 20, or may be a product of the SOH and a predetermined reference value related to the SOH.

In an embodiment, the coefficient decision unit 622 decides the power supply coefficient of each connection module, based on, for example, at least one of (i) the equivalent series resistance, (ii) the slope of the SOC-OCV curve, or (iii) the SOH of each connection module. In another embodiment, the coefficient decision unit 622 decides the power reception coefficient of each connection module, based on, for example, at least one of (i) the equivalent series resistance, (ii) the slope of the SOC-OCV curve, or (iii) the SOH of each connection module.

In the present embodiment, the upper limit power decision unit 624 decides the upper limit of the magnitude of at least one of the output power or the input power of the power supply system 100. In an embodiment, the upper limit value of the magnitude of the output power and the upper limit value of the magnitude of the input power may be the same. In another embodiment, the upper limit value of the magnitude of the output power and the upper limit value of the magnitude of the input power may be different. For example, when a peak cut of the power is performed, the upper limit value of the magnitude of the output power may be different from the upper limit value of the magnitude of the input power.

In an embodiment, the upper limit power decision unit 624 decides the upper limit of the magnitude of the output power of the power supply system 100, based on, for example, the maximum power supply value of each of the one or more connection modules described above. For example, the upper limit power decision unit 624 decides a sum of the maximum power supply values of one or more connection modules as the upper limit of the magnitude of the output power of the power supply system 100.

For example, the upper limit power decision unit 624 decides the upper limit of the magnitude of the output power of the power supply system 100, based on the maximum power supply value of each of one or more connection modules and the power supply coefficient decided for each of the one or more connection modules. The upper limit power decision unit 624 may decide, as the upper limit of the magnitude of the output power of the power supply system 100, a weighted linear sum of the maximum power supply values of one or more connection modules using the power supply coefficient of each connection module as a weight.

In these embodiments, the power supply coefficient may be equal to or greater than 0.2 and equal to or less than 1. For example, when the electric storage units 210 of one or more connection modules have different or dissimilar battery systems, the power supply coefficient may be equal to or greater than 0.2 and equal to or less than 1. In these embodiments, the power supply coefficient may be equal to or greater than 0.8 and equal to or less than 1. For example, when the electric storage units 210 of one or more connection modules have same or similar battery systems, the power supply coefficient may be equal to or greater than 0.8 and equal to or less than 1.

In another embodiment, the upper limit power decision unit 624 decides the upper limit of the magnitude of the input power of the power supply system 100, based on, for example, the maximum power reception value of each of the one or more connection modules described above. For example, the upper limit power decision unit 624 decides a sum of the maximum power reception values of one or more connection modules as the upper limit of the magnitude of the input power of the power supply system 100.

For example, the upper limit power decision unit 624 decides the upper limit of the magnitude of the input power of the power supply system 100, based on the maximum power reception value of each of one or more connection modules and the power reception coefficient decided for each of the one or more connection modules. The upper limit power decision unit 624 may decide, as the upper limit of the magnitude of the input power of the power supply system 100, a weighted linear sum of the maximum power reception values of one or more connection modules using the power reception coefficient of each connection module as a weight.

In these embodiments, the power reception coefficient may be equal to or greater than 0.2 and equal to or less than 1. For example, when the electric storage units 210 of one or more connection modules have different or dissimilar battery systems, the power reception coefficient may be equal to or greater than 0.2 and equal to or less than 1. In these embodiments, the power reception coefficient may be equal to or greater than 0.8 and equal to or less than 1. For example, when the electric storage units 210 of one or more connection modules have same or similar battery systems, the power reception coefficient may be equal to or greater than 0.8 and equal to or less than 1.

In the present embodiment, the allowable current decision unit 632 acquires an allowable value of a current flowing between each of one or more connection modules and the power connector 122 of the slot 120 holding each connection module (may be referred to as an allowable current value). The allowable current decision unit 632 decides the allowable current value of each of one or more connection modules, based on, for example, at least one of the maximum power supply value or the maximum power reception value of each connection module. Accordingly, the allowable current decision unit 632 can acquire the allowable current value of each connection module.

In an embodiment, when the maximum power decision unit 614 derives, as the maximum power supply value, the maximum value of the power which the connection module can supply to the power supply system 100, the allowable current decision unit 632 decides the allowable current value of each connection module, based on, for example, the maximum power supply value of each of one or more connection modules and a voltage of each connection module at that time point. The allowable current decision unit 632 decides the allowable current value of each of one or more connection modules, based on, for example, the maximum power reception value of each connection module and the voltage of each connection module.

In another embodiment, when the maximum power decision unit 614 derives, as the maximum power supply value, the maximum value of the current which the connection module can supply to the power supply system 100, the allowable current decision unit 632 may decide, as the allowable current value of the connection module, the maximum power supply value output by the maximum power decision unit 614.

In the present embodiment, the upper limit current decision unit 634 decides the upper limit of the magnitude of at least one of the output current or the input current of the power supply system 100. For example, the upper limit current decision unit 634 decides the upper limit of the magnitude of at least one of the output current or the input current of the power supply system 100, based on the allowable current value decided or acquired by the allowable current decision unit 632.

For example, when a number of connection modules increases, the upper limit current decision unit 634 decides an appropriate upper limit while gradually increasing at least one of the output current or the input current of the power supply system 100. Specifically, first, when the increase detection unit 646 detects that the number of connection modules has increased, the upper limit current decision unit 634 controls the current increasing unit 648 to gradually increase at least one of the output current or the input current of the power supply system 100.

Next, when at least one of the output current or the input current of the power supply system 100 increases in response to an instruction or decision of the current increasing unit 648, the upper limit current decision unit 634 monitors a current value of the current flowing between each of one or more connection modules and the power connector 122 of the slot 120 holding each connection module. The upper limit current decision unit 634 periodically acquires, for example, information indicating the above-described current value.

The upper limit current decision unit 634 compares the above-described current value related to each connection module with the allowable current value of each connection module while monitoring the above-described current value related to each connection module. As a result of the above-described comparison, when it is determined that an absolute value of a difference between (i) the current value of the current flowing between at least one of one or more connection modules and the power connector 122 of the slot 120 holding the at least one connection module, and (ii) the allowable current value of the at least one connection module is less than a predetermined value, the upper limit current decision unit 634 decides the magnitude of at least one of the output current or the input current of the power supply system 100 at that time point, as the upper limit of at least one of the output current or the input current of the power supply system 100. Accordingly, the appropriate upper limit value can be decided.

In the present embodiment, the operation control unit 640 controls an operation of each unit of the power conditioner 130. The operation control unit 640 controls, for example, the operation of at least one of the DC/DC converter 160, the inverter 170, the switch 172, or the switch 174.

In the present embodiment, the decrease detection unit 642 monitors a fluctuation in the number of one or more electric storage modules 20 (as described above, referred to as connection module(s)) electrically connected to the power supply system 100 during the period in which the power supply system 100 outputs power. The decrease detection unit 642 may detect a decrease in the number of connection modules in a near future.

For example, the decrease detection unit 642 detects the decrease in the number of connection modules in the near future before the number of connection modules actually decreases. More specifically, the decrease detection unit 642 receives the advance notice signal transmitted by the communication unit 460 of the specific electric storage module 20, to detect the decrease in the number of connection modules in advance. The decrease detection unit 642 outputs, to the current reduction unit 644, information indicating the decrease in the number of connection modules.

In the present embodiment, the current reduction unit 644 decides to reduce the output current of the power supply system 100 when the decrease detection unit 642 detects the decrease in the number of connection modules in advance. The current reduction unit 644 may generate a signal for operating the power conditioner 130 according to a decision result. The current reduction unit 644 may transmit the above-described signal to a related component of components of the power conditioner 130. Examples of the above-described components include at least one of the DC/DC converter 160, the inverter 170, the switch 172, or the switch 174.

The above-described output current may be a current output via the power connector 152 and the power connector 154. The above-described output current may be a current output from the power connector 144 to the DC/DC converter 160. The above-described output current may be a current output from the DC/DC converter 160 to the inverter 170.

The above-described current may be a current output from the power conditioner 130 to the plurality of slots 120. The above-described current may be a current output via the power connector 144.

When the decrease detection unit 642 detects the decrease in the number of connection modules in advance, the current reduction unit 644 may reduce the output current from the connection module before the number of connection modules actually decreases. As described above, after the communication unit 460 of the electric storage module 20 transmits the advance notice signal, the switching unit 230 of the electric storage module 20 electrically disconnects the electric storage unit 210 of the electric storage module 20 from the power connector 122 of the slot 120 holding the electric storage module 20. Accordingly, the number of connection modules is reduced.

According to the present embodiment, after the output current of the power supply system 100 decreases, the electric storage unit 210 of the electric storage module 20 is electrically disconnected from the power connector 122 of the slot 120 holding the electric storage module 20. Accordingly, the magnitude of the output current of each of remaining connection modules is controlled to be equal to or less than the upper limit of the magnitude of the output current of each connection module.

In the present embodiment, the increase detection unit 646 monitors a fluctuation in the number of connection modules. The increase detection unit 646 may monitor a fluctuation in the number of connection modules during the period in which the power supply system 100 outputs power. The increase detection unit 646 detects, for example, an increase in the number of connection modules. The increase detection unit 646 outputs, to the current reduction unit 644, information indicating that the number of connection modules increases.

In the present embodiment, the current increasing unit 648 decides to increase at least one of the output current or the input current of the power supply system 100 when the increase detection unit 646 detects the increase in the number of connection modules. When the increase detection unit 646 detects the increase in the number of connection modules, the current increasing unit 648 decides to increase at least one of the output current or the input current of the power supply system 100 such that, for example, a fluctuation in at least one of the output current or the input current of the power supply system 100 satisfies a predetermined first condition. Examples of the first condition include a condition that an increasing speed of at least one of the output current or the input current is equal to or less than a predetermined value, a condition that the increasing speed is within a predetermined numerical range, and the like.

In the present embodiment, the current increasing unit 648 adjusts a timing to start processing for increasing at least one of the output current or the input current of the power supply system 100, such that at least one of the output current or the input current of the power supply system 100 increases after a predetermined delay time has elapsed since the increase detection unit 646 detects the increase in the number of connection modules. The delay time may have a predetermined length or a length decided based on a predetermined algorithm. Accordingly, the operation of the power supply system 100 is further stabilized.

The current increasing unit 648 may generate a signal for operating the power conditioner 130 according to the decision result. The current increasing unit 648 may transmit the above-described signal to a related component of the components of the power conditioner 130. Examples of the above-described components include at least one of the DC/DC converter 160, the inverter 170, the switch 172, or the switch 174.

As described above, according to the present embodiment, when the input/output control unit 180 receives a signal requesting an increase in charge/discharge current, the input/output control unit 180 acquires, from a current sensor that detects a magnitude of a current of each of one or more electric storage modules 20, information indicating the magnitude of the current of each electric storage module. The input/output control unit 180 controls the output of the power conditioner 130 such that the current value of each electric storage module does not exceed a limit value of the current of each electric storage module, while monitoring the magnitude of the current of each electric storage module.

For example, when each electric storage module has different electrical characteristics, it is difficult to predict the magnitude of the current distributed to each electric storage module. When batteries having different types and/or specifications are mixed, it is particularly difficult to predict the magnitude of the current distributed to each electric storage module. Even in such a case, according to the present embodiment, the magnitude of the current distributed to each electric storage module can be appropriately adjusted.

In addition, for example, depending on an ON/OFF timing of the switching unit 230, the current may flow backward, and a charge efficiency or a discharge efficiency may decrease. As described above, by providing the delay time, a decrease in charge efficiency or discharge efficiency can be suppressed.

The allowable current decision unit 632 may be an example of an allowable current acquisition unit. The electric storage module 20 that transmits the advance notice signal may be an example of the second electric storage apparatus.

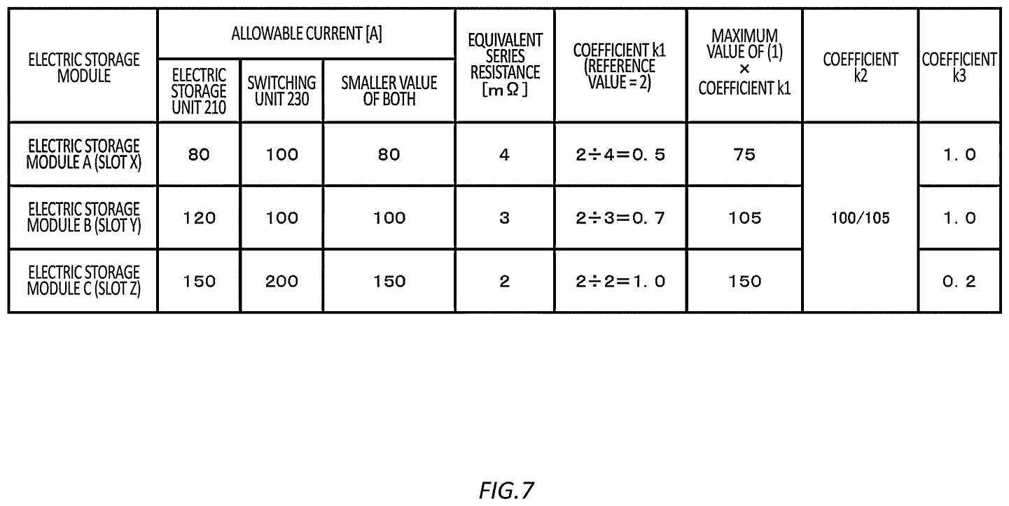

Next, an example of a procedure for deciding the upper limit of the magnitude of the output power of the power supply system 100 will be described with reference to FIG. 7. In the present embodiment, for the purpose of facilitating the description, a case where the power supply system 100 includes a slot X, a slot Y, and a slot Z, an electric storage module A is attached in the slot X, an electric storage module B is attached in the slot Y, and an electric storage module C is attached in the slot Z is used as an example to describe details of the above-described procedure. Those skilled in the art having access to the above description can understand that the upper limit of the magnitude of the input power of the power supply system 100 can be decided using similar procedures.

According to the present embodiment, for example, the maximum power decision unit 614 decides the maximum value of the power which each electric storage module can supply to the power supply system 100, based on the smaller value of the rated output current of the electric storage unit 210 and the rated output current of the switching unit 230. For example, the maximum power decision unit 614 first decides the maximum value of the current which each electric storage module can supply to the power supply system 100. Next, the maximum power decision unit 614 decides the maximum value of the power which each electric storage module can supply to the power supply system 100, based on the above-described maximum value of the current related to each electric storage module and a voltage of each electric storage module at that time point.

More specifically, first, the allowable current decision unit 632 decides the allowable current of each electric storage module. For example, the allowable current decision unit 632 acquires the value of the rated output current of the electric storage unit 210 of each electric storage module from the rated information acquisition unit 612. Similarly, the allowable current decision unit 632 acquires the value of the rated output current of the switching unit 230 of each electric storage module from the rated information acquisition unit 612. As illustrated in FIG. 7, in the present embodiment, the rated output currents of the electric storage units 210 of the electric storage module A, the electric storage module B, and the electric storage module C are 80, 120, and 150 (A), respectively. Similarly, the rated output currents of the switching units 230 of the electric storage module A, electric storage module B, and electric storage module C are 100, 100, and 200 (A), respectively.

Next, the allowable current decision unit 632 compares the rated output current of the electric storage unit 210 with the rated output current of the switching unit 230 for each electric storage module. For each electric storage module, the allowable current decision unit 632 decides, as the allowable current of each electric storage module, the smaller value of the rated output current of electric storage unit 210 and the rated output current of switching unit 230.

Next, the coefficient decision unit 622 acquires a value of the equivalent series resistance of each electric storage module. As illustrated in FIG. 7, in the present embodiment, the equivalent series resistances of the electric storage module A, the electric storage module B, and the electric storage module C are 4, 3, and 2 (mΩ), respectively. The coefficient decision unit 622 decides a first coefficient k1 based on the reciprocal of the equivalent series resistance of each electric storage module. In the present embodiment, the coefficient decision unit 622 decides the first coefficient k1 based on a reference value of 2 and the reciprocal of the equivalent series resistance of each electric storage module. Specifically, the coefficient decision unit 622 calculates the first coefficient k1 of each electric storage module by dividing the reference value of 2 by the reciprocal of the equivalent series resistance of each electric storage module.

The coefficient decision unit 622 then compares (i) a value obtained by multiplying a largest value of the allowable currents of the three electric storage modules by the first coefficient k1 of each electric storage module (may be referred to as a first multiplication value) and (ii) a value of the allowable current of each electric storage module. For at least one electric storage module, when the first multiplication value is greater than the allowable current value, the coefficient decision unit 622 derives a second coefficient k2 for adjusting the first coefficient k1. For example, for the electric storage module in which the first multiplication value is greater than the allowable current value, the coefficient decision unit 622 calculates the second coefficient k2 by dividing the value of the allowable current by the first multiplication value. When there are a plurality of electric storage modules in which the first multiplication value is greater than the allowable current value, the coefficient decision unit 622 decides to use, as the second coefficient k2, a smallest value among values obtained by dividing the values of the allowable currents of the plurality of electric storage modules by the first multiplication values. The second coefficient may be a coefficient common to all the electric storage modules.

Next, the coefficient decision unit 622 acquires a value of the slope of the SOC-OCV curve of each electric storage module. The coefficient decision unit 622 decides, as a third coefficient k3, the slope of the SOC-OCV curve of each electric storage module at a point corresponding to a present voltage on the curve.

Next, the allowable current decision unit 632 acquires the values of the first coefficient k1, the second coefficient k2, and the third coefficient k3 of each electric storage module from the coefficient decision unit 622. The allowable current decision unit 632 multiplies the allowable current of each electric storage module by the first coefficient k1, the second coefficient k2, and the third coefficient k3 to decide the maximum value of the current which each electric storage module can supply to the power supply system 100. According to the embodiment described in connection with FIG. 7, the maximum values of the currents which the electric storage module A, the electric storage module B, and the electric storage module C can supply to the power supply system 100 are 71, 100, and 28 (A), respectively. A maximum value of a current which the power supply system 100 can supply to an outside is 199 (A), which is a sum of them.

The maximum power decision unit 614 can multiply the maximum value of the output current of each electric storage module decided by the allowable current decision unit 632 by a voltage of each electric storage module at that time point, to decide the maximum value of the power which each electric storage module can supply to the power supply system 100. Similarly, the maximum power decision unit 614 can decide the maximum value of the power which the power supply system 100 can supply to the outside, based on the maximum value of the output current of each electric storage module decided by the allowable current decision unit 632 and the voltage of each electric storage module at that time point. The maximum power decision unit 614 outputs, to the operation control unit 640, information indicating the maximum value of the power which the power supply system 100 can supply to the outside. The operation control unit 640 controls the operation of the power conditioner 130 based on the information acquired from maximum power decision unit 614.

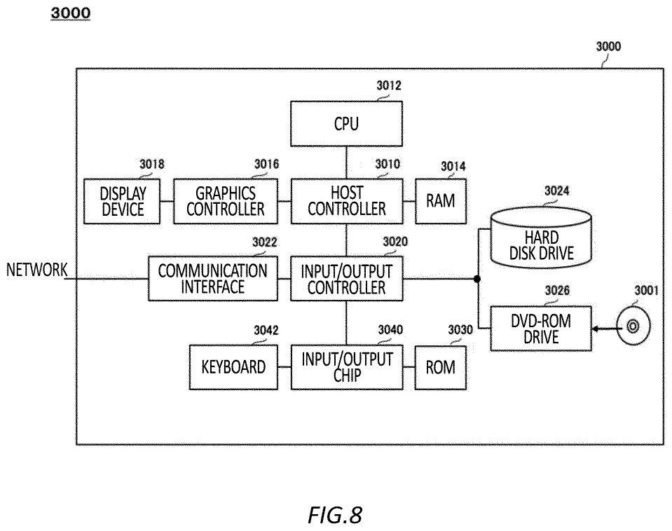

FIG. 8 schematically illustrates an example of a system configuration of a computer 3000. For example, at least a part of the power supply system 100 is realized by the computer 3000. For example, at least a part of the input/output control unit 180 is realized by the computer 3000. For example, at least a part of the module control unit 240 is realized by the computer 3000.

A program that is installed in the computer 3000 can cause the computer 3000 to perform an operation associated with an apparatus according to the embodiment of the present invention or to function as one or a plurality of “units” of the apparatus, or can cause the computer 3000 to perform the operation or said one or plurality of units thereof, and/or cause the computer 3000 to perform processes of the embodiment of the present invention or steps thereof. Such a program may be executed by a CPU 3012 to cause the computer 3000 to perform particular operations associated with some or all of the blocks of flowcharts and block diagrams described in the present specification.

The computer 3000 according to the present embodiment includes the CPU 3012, a RAM 3014, a graphics controller 3016 and a display device 3018, and they are connected to each other by a host controller 3010. The computer 3000 further includes a communication interface 3022, a hard disk drive 3024, a DVD-ROM drive 3026 and an input/output unit such as an IC card drive, and they are connected to the host controller 3010 via an input/output controller 3020. The computer also includes legacy input/output units such as a ROM 3030 and a keyboard 3042, which are connected to the input/output controller 3020 through an input/output chip 3040.

The CPU 3012 operates according to programs stored in the ROM 3030 and the RAM 3014, thereby controlling each unit. The graphics controller 3016 acquires image data generated by the CPU 3012 on a frame buffer or the like provided in the RAM 3014 or in itself, and causes the image data to be displayed on the display device 3018.

The communication interface 3022 communicates with other electronic devices via the network. The hard disk drive 3024 stores the program and data to be used by the CPU 3012 in the computer 3000. The DVD-ROM drive 3026 reads a program or data from a DVD-ROM 3001, and provides the program or data to the hard disk drive 3024 via the RAM 3014. The IC card drive reads programs and data from an IC card and/or writes programs and data into the IC card.

The ROM 3030 stores therein a boot program or the like that is executed by the computer 3000 at the time of activation, and/or a program depending on the hardware of the computer 3000. The input/output chip 3040 may also connect various input/output units to the input/output controller 3020 via a parallel port, a serial port, a keyboard port, a mouse port, or the like.

A program is provided by a computer readable storage medium, such as the DVD-ROM 3001 or the IC card. The program is read from the computer readable storage medium, installed into the hard disk drive 3024, RAM 3014, or ROM 3030, which are also examples of the computer readable storage medium, and executed by the CPU 3012. The information processing written in these programs is read into the computer 3000, resulting in cooperation between a program and the above various types of hardware resources. An apparatus or method may be configured by implementing an operation or processing of information in accordance with the use of the computer 3000.

For example, if a communication is executed between the computer 3000 and an external device, the CPU 3012 may execute the communication program loaded on the RAM 3014 to instruct communication processing, based on the processing described in the communication program, to the communication interface 3022. The communication interface 3022 reads, under the control by the CPU 3012, the transmission data stored in the transmission buffer region provided in a storage medium such as the RAM 3014, the hard disk drive 3024, the DVD-ROM 3001 or the IC card, sends the transmission data so read to the network, or writes the received data received from the network into a reception buffer region etc. provided on the storage medium.

In addition, the CPU 3012 may cause all or a necessary portion of a file or a database to be read into the RAM 3014, the file or the database having been stored in an external recording medium such as the hard disk drive 3024, the DVD-ROM drive 3026 (DVD-ROM 3001), the IC card, and the like, and execute various types of processing on the data on the RAM 3014. Next, the CPU 3012 may write back the processed data into an external recording medium.

Various types of information, such as various types of programs, data, tables, and databases, may be stored in the recording medium to undergo information processing. The CPU 3012 may execute, against the data read from the RAM 3014, various types of processing, including various types of operations designated by an instruction sequence of a program, which are described throughout this disclosure, information processing, a condition judgment, a conditional branch, an unconditional branch, information search/replacement, and the like, and write back the result to the RAM 3014. In addition, the CPU 3012 may search for information in a file, a database, or the like, in the recording medium. For example, when a plurality of entries, each having an attribute value of a first attribute associated with an attribute value of a second attribute, are stored in the recording medium, the CPU 3012 may search for an entry whose attribute value of the first attribute matches a designated condition, from among said plurality of entries, and read the attribute value of the second attribute stored in said entry, thereby acquiring the attribute value of the second attribute associated with the first attribute satisfying the predetermined condition.

The above-described program or software modules may be stored in the computer readable storage medium on or near the computer 3000. In addition, a recording medium such as a hard disk or a RAM provided within a server system connected to a dedicated communication network or the Internet can be used as a computer readable storage medium, to thereby provide the above program to the computer 3000 via the network.

While the present invention has been described by way of the embodiments, the technical scope of the present invention is not limited to the above-described embodiments. It is apparent to persons skilled in the art that various alterations or improvements can be made to the above described embodiments. In addition, the matters described with regard to the particular embodiment can be applied to other embodiments with a range without causing technical contradictions. It is also apparent from the scope of the claims that the embodiments added with such alterations or improvements can be included in the technical scope of the invention.

It should be noted that the operations, procedures, steps, stages, or the like of each process performed by an apparatus, system, program, and method shown in the claims, the specification, or the drawings can be performed in any order as long as the order is not indicated by “prior to,” “before,” or the like and as long as the output from a previous process is not used in a later process. Even if the process flow is described using phrases such as “first” or “next” in the claims, the specification, or the drawings for the sake of convenience, it does not necessarily mean that the process must be performed in this order.

### EXPLANATION OF REFERENCES

10: power grid; 12: distribution board; 20: electric storage module; 22: power connector; 24: communication connector; 30: load apparatus; 52: signal; 54: signal; 100: power supply system; 110: photovoltaic apparatus; 120: slot; 122: power connector; 124: communication connector; 130: power conditioner; 142: power connector; 144: power connector; 148: communication connector; 152: power connector; 154: power connector; 160: DC/DC converter; 170: inverter; 172: switch; 174: switch; 180: input/output control unit; 202: positive electrode terminal; 204: negative electrode terminal; 210: electric storage unit; 212: positive electrode terminal; 214: negative electrode terminal; 222: electric storage cell; 224: electric storage cell; 230: switching unit; 240: module control unit; 250: protection unit; 260: balance correction unit; 320: trickle charging unit; 322: direction limiting unit; 324: flow limiting unit; 410: determination unit; 420: reception unit; 430: signal generation unit; 440: module information acquisition unit; 450: module information storage unit; 460: communication unit; 510: transistor; 512: resistor; 514: resistor; 516: diode; 520: transistor; 522: resistor; 524: resistor; 526: diode; 530: transistor; 532: resistor; 540: transistor; 542: resistor; 552: resistor; 554: resistor; 560: transistor; 570: capacitor; 572: resistor; 580: transistor; 592: switch; 594: switch; 612: rated information acquisition unit; 614: maximum power decision unit; 622: coefficient decision unit; 624: upper limit power decision unit; 632: allowable current decision unit; 634: upper limit current decision unit; 640: operation control unit; 642: decrease detection unit; 644: current reduction unit; 646: increase detection unit; 648: current increasing unit; 3000: computer; 3001: DVD-ROM; 3010: host controller; 3012: CPU; 3014: RAM; 3016: graphics controller; 3018: display device; 3020: input/output controller; 3022: communication interface; 3024: hard disk drive; 3026: DVD-ROM drive; 3030: ROM; 3040: input/output chip; and 3042: keyboard.

What is claimed is:

1. A control apparatus for controlling at least one of output power or input power of a power apparatus configured such that electric storage apparatuses, which are attachable and detachable, are able to be connected in parallel, the control apparatus comprising
an upper limit power decision unit which decides an upper limit of a magnitude of the at least one of the output power or the input power of the power apparatus, wherein
the upper limit power decision unit
decides the upper limit of the magnitude of the output power of the power apparatus, based on a maximum power supply value that is a maximum value of power which each of one or more first electric storage apparatuses, which are the electric storage apparatuses electrically connected to a power terminal of the power apparatus, is able to supply to the power apparatus, and/or
decides the upper limit of the magnitude of the input power of the power apparatus, based on a maximum power reception value that is a maximum value of power with which each of the one or more first electric storage apparatuses is able to be supplied from the power apparatus.

2. The control apparatus according to claim 1, wherein
the upper limit power decision unit
decides, as the upper limit of the magnitude of the output power of the power apparatus, a sum of respective maximum power supply values, including the maximum power supply value, of the one or more first electric storage apparatuses; and/or
decides, as the upper limit of the magnitude of the input power of the power apparatus, a sum of respective maximum power reception values, including the maximum power reception value, of the one or more first electric storage apparatuses.

3. The control apparatus according to claim 1, wherein
the upper limit power decision unit
decides the upper limit of the magnitude of the output power of the power apparatus, based on the maximum power supply value of each of the one or more first electric storage apparatuses and a power supply coefficient which is decided for each of the one or more first electric storage apparatuses and is a positive number equal to or less than 1, and/or
decides the upper limit of the magnitude of the input power of the power apparatus, based on the maximum power reception value of each of the one or more first electric storage apparatuses and a power reception coefficient which is decided for each of the one or more first electric storage apparatuses and is a positive number equal to or less than 1.

4. The control apparatus according to claim 3, wherein
the power supply coefficient of each of the one or more first electric storage apparatuses is decided based on at least one of (i) an equivalent series resistance, (ii) a slope of an SOC-OCV curve, or (iii) an SOH of each of the one or more first electric storage apparatuses.

5. The control apparatus according to claim 3, wherein
the power reception coefficient of each of the one or more first electric storage apparatuses is decided based on at least one of (i) an equivalent series resistance, (ii) a slope of an SOC-OCV curve, or (iii) an SOH of each of the one or more first electric storage apparatuses.

6. The control apparatus according to claim 1, wherein
the maximum power supply value of each of the one or more first electric storage apparatuses is decided based on a smaller value of (a) a rated output power of an electric storage unit of each of the one or more first electric storage apparatuses, and (b) a rated output power of a switching unit which switches an electrical connection relationship between the electric storage unit of each of the one or more first electric storage apparatuses and the power terminal of the power apparatus.

7. The control apparatus according to claim 1, wherein
the maximum power reception value of each of the one or more first electric storage apparatuses is decided based on a smaller value of (a) a rated input power of an electric storage unit of each of the one or more first electric storage apparatuses, and (b) a rated input power of a switching unit which switches an electrical connection relationship between the electric storage unit of each of the one or more first electric storage apparatuses and the power terminal of the power apparatus.

8. The control apparatus according to claim 1, further comprising:
a decrease detection unit which detects in advance that a decrease in a number of the one or more first electric storage apparatuses occurs during a period in which the power apparatus outputs power; and
a current reduction unit which decides, when the decrease detection unit detects the decrease in the number in advance, to reduce an output current of the power apparatus such that the output current of the power apparatus decreases before the number of the one or more first electric storage apparatuses decreases.

9. The control apparatus according to claim 1, comprising:
an increase detection unit which detects an increase in a number of the one or more first electric storage apparatuses;
an allowable current acquisition unit which acquires an allowable current value indicating an allowable value of a current flowing between each of the one or more first electric storage apparatuses and the power terminal of the power apparatus;
an upper limit current decision unit which decides an upper limit of a magnitude of at least one of an output current or an input current of the power apparatus, based on the allowable current value acquired by the allowable current acquisition unit; and
a current increasing unit which makes a decision, when the increase detection unit detects the increase in the number, to increase the at least one of the output current or the input current of the power apparatus such that a fluctuation in the at least one of the output current or the input current of the power apparatus satisfies a predetermined first condition, wherein
the allowable current value of each of the one or more first electric storage apparatuses is decided based on at least one of the maximum power supply value or the maximum power reception value of each of the one or more first electric storage apparatuses, and
the upper limit current decision unit
acquires, when the at least one of the output current or the input current of the power apparatus increases according to the decision of the current increasing unit, a current value of a current flowing between each of the one or more first electric storage apparatuses and the power terminal of the power apparatus, and
decides, when an absolute value of a difference between (i) a current value of a current flowing between at least one first electric storage apparatus of the one or more first electric storage apparatuses and the power terminal of the power apparatus and (ii) the allowable current value of the at least one first electric storage apparatus is less than a predetermined value, a magnitude of the at least one of the output current or the input current of the power apparatus as the upper limit of the magnitude of the at least one of the output current or the input current of the power apparatus.

10. A control apparatus for controlling at least one of an output current or an input current of a power apparatus configured such that electric storage apparatuses, which are attachable and detachable, are able to be connected in parallel, the control apparatus comprising:
an increase detection unit which detects an increase in a number of one or more first electric storage apparatuses which are the electric storage apparatuses electrically connected to a power terminal of the power apparatus;
an allowable current acquisition unit which acquires an allowable current value indicating an allowable value of a current flowing between each of the one or more first electric storage apparatuses and the power terminal of the power apparatus;
an upper limit current decision unit which decides an upper limit of a magnitude of at least one of the output current or the input current of the power apparatus, based on the allowable current value acquired by the allowable current acquisition unit; and
a current increasing unit which makes a decision, when the increase detection unit detects the increase in the number, to increase the at least one of the output current or the input current of the power apparatus such that a fluctuation in the at least one of the output current or the input current of the power apparatus satisfies a predetermined first condition, wherein
the upper limit current decision unit
acquires, when the at least one of the output current or the input current of the power apparatus increases according to the decision of the current increasing unit, a current value of a current flowing between each of the one or more first electric storage apparatuses and the power terminal of the power apparatus, and
decides, when an absolute value of a difference between (i) a current value of a current flowing between at least one first electric storage apparatus of the one or more first electric storage apparatuses and the power terminal of the power apparatus and (ii) the allowable current value of the at least one first electric storage apparatus is less than a predetermined value, a magnitude of the at least one of the output current or the input current of the power apparatus as the upper limit of the magnitude of the at least one of the output current or the input current of the power apparatus.

11. The control apparatus according to claim 10, wherein
the current increasing unit adjusts a timing to start processing for increasing the at least one of the output current or the input current of the power apparatus, such that the at least one of the output current or the input current of the power apparatus increases after a predetermined delay time has elapsed since the increase detection unit detects the increase in the number, and
the delay time has a predetermined length or a length decided based on a predetermined algorithm.

12. The control apparatus according to claim 10, wherein
the allowable current acquisition unit includes
an allowable current decision unit which decides the allowable current value of each of the one or more first electric storage apparatuses based on at least one of (i) a maximum power supply value that is a maximum value of power which each of the one or more first electric storage apparatuses is able to supply to the power apparatus or (ii) a maximum power reception value that is a maximum value of power with which each of the one or more first electric storage apparatuses is able to be supplied from the power apparatus.

13. The control apparatus according to claim 10, further comprising:
a decrease detection unit which detects in advance that a decrease in a number of the one or more first electric storage apparatuses occurs during a period in which the power apparatus outputs power; and
a current reduction unit which decides, when the decrease detection unit detects the decrease in the number in advance, to reduce the output current of the power apparatus such that the output current of the power apparatus decreases before the number of the one or more first electric storage apparatuses decreases.

14. A power adjustment apparatus comprising:
the control apparatus according to claim 1; and
a power adjustment unit which adjusts at least one of input power or output power of a power supply apparatus based on an instruction from the control apparatus.

15. A power apparatus comprising:
the power adjustment apparatus according to claim 14;
a holding unit which is configured to be able to hold each of the electric storage apparatuses which are attachable and detachable; and
a power terminal which is configured to be able to input and output power to and from external electrical equipment, wherein
the power adjustment apparatus adjusts input and output of power between the electric storage apparatuses, which are attachable and detachable, and the external electrical equipment.

16. A power adjustment apparatus comprising:
the control apparatus according to claim 10; and
a power adjustment unit which adjusts at least one of input power or output power of a power supply apparatus based on an instruction from the control apparatus.

17. A control system comprising:
the control apparatus according to claim 8;
a transmission unit which transmits, to the control apparatus, an advance notice signal for giving advance notice of a decrease in a number of the one or more first electric storage apparatuses, when a voltage difference between an electric storage unit of a second electric storage apparatus included in the one or more first electric storage apparatuses and the power terminal of the power apparatus meets a predetermined second condition during a period in which the power apparatus outputs power; and
a disconnection unit which decides to electrically disconnect the power terminal of the power apparatus from the second electric storage apparatus when a predetermined third condition is satisfied after the transmission unit outputs the advance notice signal.

18. The control system according to claim 17, wherein
the second condition includes
a condition that the voltage difference is less than a predetermined value, or
a condition that an absolute value of the voltage difference is less than a predetermined value, and
the third condition includes
a condition that a predetermined time has elapsed since the transmission unit outputs the advance notice signal, or
a condition that, after the transmission unit outputs the advance notice signal, the disconnection unit receives, from the control apparatus, a signal indicating that processing for reducing an output current of the power apparatus has started or that the processing has been completed.

19. A control system comprising:
the control apparatus according to claim 13;
a transmission unit which transmits, to the control apparatus, an advance notice signal for giving advance notice of a decrease in a number of the one or more first electric storage apparatuses, when a voltage difference between an electric storage unit of a second electric storage apparatus included in the one or more first electric storage apparatuses and the power terminal of the power apparatus meets a predetermined second condition during a period in which the power apparatus outputs power; and
a disconnection unit which decides to electrically disconnect the power terminal of the power apparatus from the second electric storage apparatus when a predetermined third condition is satisfied after the transmission unit outputs the advance notice signal.

20. A management apparatus which manages a state of an electric storage apparatus which is configured to be attachable and detachable to and from a power apparatus configured to be able to input and output power to and from external electrical equipment, the management apparatus comprising:
a transmission unit which transmits, to a control apparatus which controls the power apparatus, an advance notice signal for giving advance notice of electrical disconnection between an electric storage unit of the electric storage apparatus and a power terminal of the power apparatus, when a voltage difference between the electric storage unit and the power terminal meets a predetermined second condition during a period in which the power apparatus to which the electric storage apparatus is attached outputs power; and
a disconnection unit which decides to electrically disconnect the power terminal of the power apparatus from the electric storage apparatus when a predetermined third condition is satisfied after the transmission unit outputs the advance notice signal, wherein
the second condition includes
a condition that the voltage difference is less than a predetermined value, or
a condition that an absolute value of the voltage difference is less than a predetermined value, and
the third condition includes
a condition that a predetermined time has elapsed since the transmission unit outputs the advance notice signal, or
a condition that, after the transmission unit outputs the advance notice signal, the disconnection unit receives, from the control apparatus, a signal indicating that processing for reducing an output current of the power apparatus has started or that the processing has been completed.
